(19) United States
(12) Patent Application Publication
(10) Pub. No.: US 2023/0415067 A1
(43) Pub. Date: Dec. 28, 2023

(54) SYSTEMS AND METHODS FOR GENERATING WATER FROM AIR

(71) Applicant: Source Global, PBC, Scottsdale, AZ (US)

(72) Inventors: Cody Friesen, Scottsdale, AZ (US); Michael Robinson, Scottsdale, AZ (US); Joshua Peterson, Scottsdale, AZ (US); Kamil Salloum, Scottsdale, AZ (US)

(73) Assignee: Source Global, PBC, Scottsdale, AZ (US)

(21) Appl. No.: 18/206,563

(22) Filed: Jun. 6, 2023

Related U.S. Application Data
(60) Provisional application No. 63/355,032, filed on Jun. 23, 2022.

(51) Int. Cl. B01D 5/00

(52) U.S. Cl. CPC B01D 5/0039; B01D 5/0015; B01D 5/0057; B01D 5/009; B01D 2257/80

(57) ABSTRACT

Systems and methods for recuperative heat exchange are described herein. Recuperative heat exchange assemblies can comprise longitudinally extending heat exchange plates defining alternating hot-side layers and cooling layers. Furthermore, water generation systems and related methods of generating water from air are disclosed herein. Water generation systems and related methods can comprise a sorption unit comprising a hygroscopic material to capture water vapor from ambient air, a thermal unit to heat the hygroscopic material and transfer water vapor released therefrom to a regeneration fluid, and a recuperative heat exchange assembly to drive condensation of water vapor from the regeneration gas to produce liquid water. Disclosed water generation systems and related methods may include a valve assembly having a slide plate movable transversely to a flow channel axis between a plurality of positions.

### CROSS-REFERENCE TO RELATED APPLICATIONS

This application claims priority to, and the benefit of, U.S. Provisional Patent Application Ser. No. 63/355,032, filed on Jun. 23, 2022, entitled “Systems and Methods for Generating Water from Air with Recuperative Heat Exchange”, the disclosure of which is hereby incorporated by reference in their entirety.

### TECHNICAL FIELD

This disclosure is related to systems and methods for generating liquid water from ambient air. Furthermore, this disclosure is related to systems and methods for heat exchange in general, particularly, high-efficiency compact counter-flow or recuperative heat exchange.

### BACKGROUND

Producing liquid water by extracting water vapor from ambient air or atmospheric air can present various challenges. Certain challenges include those associated with maximizing a water production rate and/or efficiency at a low cost and high reliability. There exists a need for improved systems and methods for producing liquid water from atmospheric air and in some cases, by compact, modular devices that are configured for high efficiency, reliability, simple manufacture and low cost. Furthermore, there exists a need for efficient and compact recuperative heat exchangers that allow for efficient transfer of heat from a “hot-side” flow to a “cold-side” flow while maintaining isolation of the two flows or streams from each other.

### BRIEF SUMMARY

In one general aspect, systems and methods for recuperative heat exchange are described herein. Recuperative heat exchange assemblies can comprise longitudinally extending heat exchange plates defining alternating hot-side layers and cooling layers. Disclosed recuperative heat exchange assemblies and methods can drive condensation of water vapor from a hot-side flow layer. Furthermore, water generation systems and related methods of generating water from air are disclosed herein. Water generation systems and related methods can comprise a sorption unit comprising a hygroscopic material to capture water vapor from ambient air, a solar or thermal unit to heat the hygroscopic material and transfer water vapor released therefrom to a regeneration fluid, and a recuperative heat exchange assembly to drive condensation of water vapor from the regeneration gas to produce liquid water. Disclosed water generation systems and related methods may include a valve assembly having a slide plate movable transversely to a flow channel axis between a plurality of positions.

Methods of recuperative heat exchange and generating water from ambient air are also disclosed herein. In various embodiments, methods of generating water from air can include converting solar radiation into heat and/or electrical energy to power the water generation system. Disclosed methods can include flowing ambient air through a sorption unit or layer comprising a hygroscopic material to capture water vapor from ambient air during a sorption mode or cycle; transitioning to a desorption mode or cycle; and, flowing a regeneration gas to accumulate water vapor from the sorption unit or layer during a desorption mode or cycle.

In one general aspect, systems and methods may include directing a regeneration fluid in a closed-loop regeneration flow path through a recuperative heat exchange assembly including: directing a first regeneration fluid flow through a hot-side layer located on a first side of a heat exchange plate; directing a second regeneration fluid flow through a cooling layer located on an opposing side of the heat exchange plate; and/or directing a cooling fluid through at least one pass in a cooling flow path. Methods may further include transferring heat through heat exchange plates between a first regeneration fluid flow in a hot-side layer of a regeneration flow path and a second regeneration fluid flow in a cold-side layer and/or a cooling fluid, such as ambient air, in a cooling layer.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale (unless otherwise noted), meaning the sizes of the depicted elements are accurate relative to each other for at least the embodiment in the view.

FIG. 1 depicts a water generation system, according to an embodiment;

FIG. 2A illustrates a block diagram of a water generation system including a process flow path during a sorption, uptake or loading operational mode or cycle, according to an embodiment;

FIG. 2B illustrates a block diagram of a water generation system including a regeneration flow path during a desorption, release or unloading operational mode or cycle, according to an embodiment;

FIG. 3A illustrates a compact water generation system having a compact configuration including a process flow path during a sorption, uptake or loading operational mode or cycle, according to an embodiment;

FIG. 3B illustrates a compact water generation system including a regeneration flow path during a desorption, release or unloading operational mode or cycle, according to an embodiment;

FIG. 4A illustrates a valve assembly including a sliding valve configuration, according to an embodiment;

FIG. 4B illustrates an exploded view of a valve assembly including a sliding valve configuration, according to an embodiment;

FIG. 5A illustrates a top-down perspective view of a recuperative heat exchange assembly, according to an embodiment;

FIG. 5B illustrates a cross-sectional side view of a recuperative heat exchange assembly, according to an embodiment;

FIG. 6 illustrates an exploded view of a recuperative heat exchange assembly, according to an embodiment;

FIG. 7A illustrates an exploded view of an upper portion of a recuperative heat exchange assembly, according to an embodiment;

FIG. 7B illustrates top-down view of a plenum layer of a recuperative heat exchange assembly, according to an embodiment;

FIG. 7C illustrates top-down view of a cooling layer of a recuperative heat exchange assembly, according to an embodiment;

FIG. 7D illustrates top-down view of a hot-side layer of a recuperative heat exchange assembly, according to an embodiment;

FIG. 8 illustrates an exploded view of a midsection of a recuperative heat exchange assembly, according to an embodiment;

FIG. 9 illustrates an exploded view of a lower portion of a recuperative heat exchange assembly, according to an embodiment;

FIG. 10 illustrates an exploded view of a recuperative heat exchange assembly, according to an embodiment;

FIG. 11 illustrates an exploded view of a recuperative heat exchange assembly, according to an embodiment;

FIG. 12A illustrates an exploded view of an upper portion or segment of a recuperative heat exchange assembly, according to an embodiment;

FIG. 12B illustrates an exploded view of a lower portion or segment of a recuperative heat exchange assembly, according to an embodiment;

FIG. 13A illustrates a side perspective view of a compact recuperative heat exchange assembly, according to an embodiment;

FIG. 13B illustrates an exploded view of a compact recuperative heat exchange assembly, according to an embodiment;

FIG. 14A illustrates a top-down perspective view of a recuperative heat exchange assembly, according to an embodiment;

FIG. 14B illustrates a top-down view of a recuperative heat exchange assembly, according to an embodiment;

FIG. 15A illustrates top-down view of a hot-side layer of a recuperative heat exchange assembly, according to an embodiment;

FIG. 15B illustrates top-down view of a cooling layer of a recuperative heat exchange assembly, according to an embodiment;

FIG. 15C illustrates top-down view of a hot-side condenser layer of a recuperative heat exchange assembly, according to an embodiment;

FIG. 15D illustrates top-down view of an ambient cooling condenser layer of a recuperative heat exchange assembly, according to an embodiment;

FIG. 15E illustrates top-down view of a return condenser layer of a recuperative heat exchange assembly, according to an embodiment;

FIG. 16 illustrates a method of operating a recuperative heat exchange system or assembly, according to an embodiment;

FIG. 17 illustrates a method of operating a water generation system, according to an embodiment; and

FIG. 18 illustrates a method of operating a water generation system, according to an embodiment.

For simplicity and clarity of illustration, the drawing figures show the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

### DESCRIPTION OF ILLUSTRATIVE EMBODIMENTS

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure.

Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Surface shading lines may be used throughout the figures to denote different parts but not necessarily to denote the same or different materials.

This disclosure includes embodiments of systems and methods, such as, for example, for water treatment and storage. The term “coupled” is defined as connected, although not necessarily directly, and not necessarily mechanically. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately” and “about” may be substituted with “within [a percentage] of” what is specified, where the percentage includes 0.1, 1, 5, and 10%. Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements Likewise, a method that “comprises,” “has,” “includes,” or “contains” one or more operations or steps possesses those one or more operations or steps, but is not limited to possessing only those one or more operations or steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. The feature or features of one embodiment may be applied to other embodiments or implementations, even though not described or illustrated, unless expressly prohibited by this disclosure or the nature of the embodiments.

As will be described in detail below, this disclosure describes various systems and methods for efficient water production from a process gas like ambient air. The systems and methods for producing water from ambient air can provide several advantages including high efficiency for water production without external power, simple deployment, quick field installation and a high degree of field serviceability and maintenance. Self-powered and highly efficient water productions systems and methods of their operation will become apparent from the following disclosure. Furthermore, compact, low profile and/or modular devices and methods of their operation to produce liquid water from atmospheric air will become apparent from the following disclosure. Additionally, the systems and methods for producing water from ambient air can provide several advantages including efficient and consistent production of liquid water using durable hygroscopic materials, composites and/or assemblies. Systems of the present disclosure can combine a hygroscopic material, composite and/or assembly design approach with an operational control approach to realize long-term operational stability and efficiencies to produce liquid water from air. In addition, the systems and methods for producing water from ambient air can provide several advantages including high quantities and production rates of liquid water using efficient condenser assemblies and operational methods without the need for external power as will become apparent from the following disclosure.

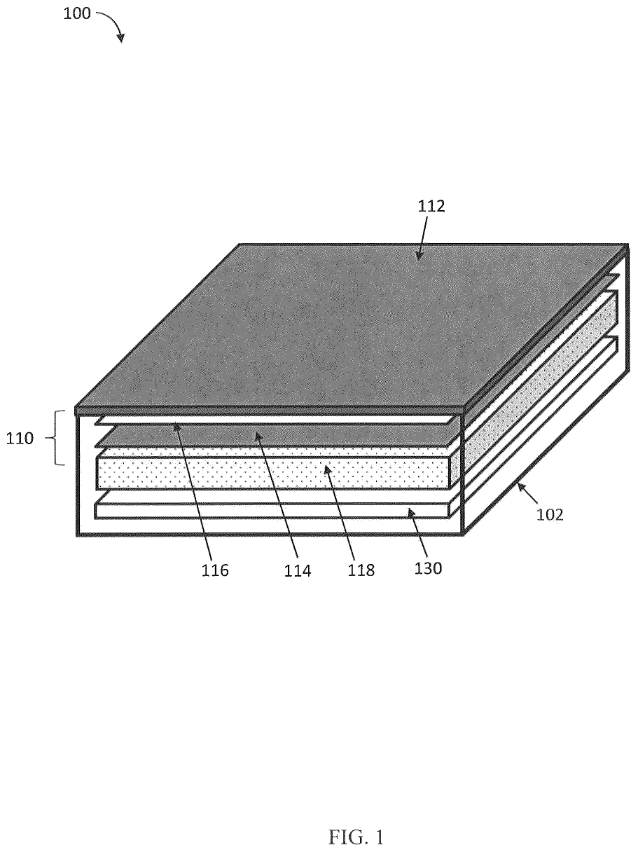

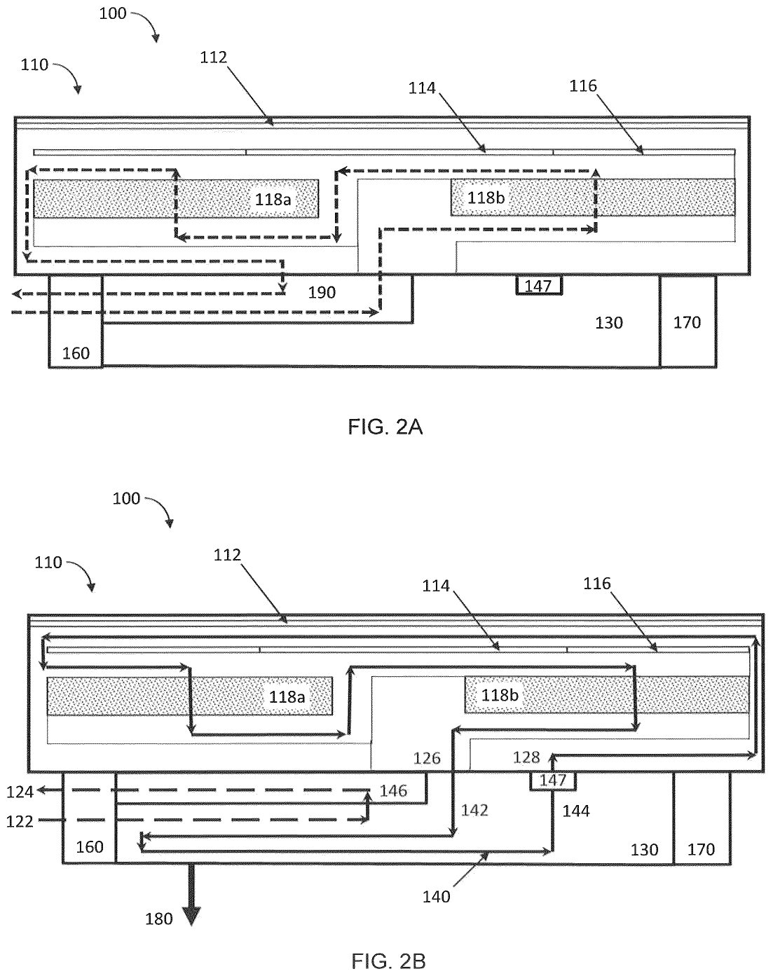

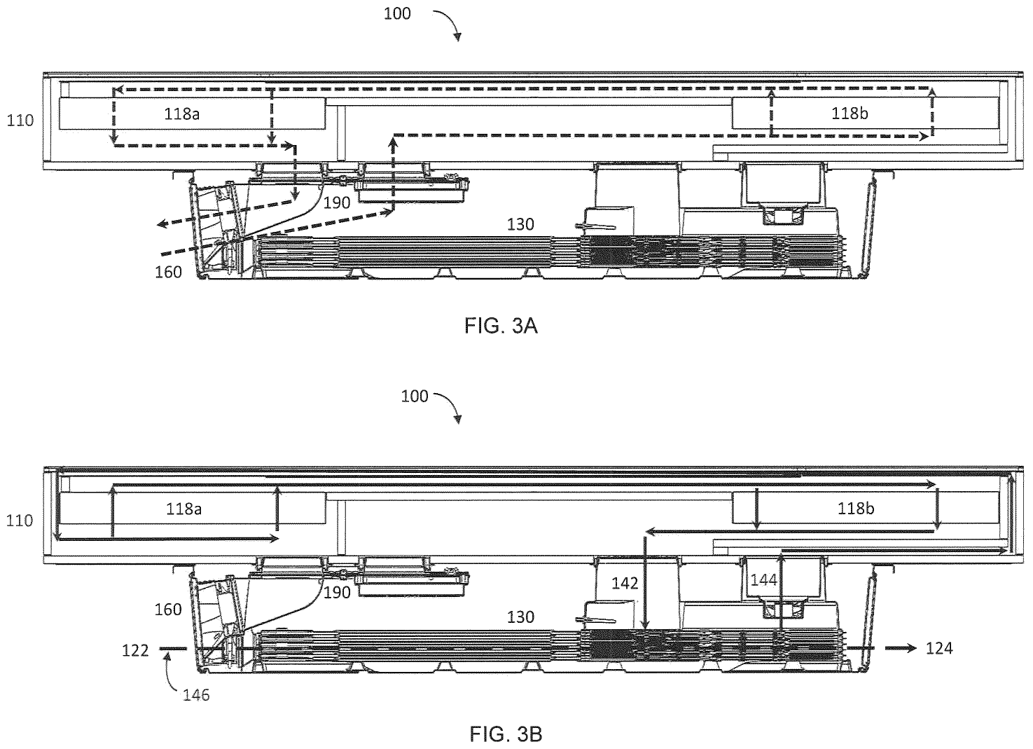

FIG. 1, FIG. 2A-B and FIG. 3A-B depict embodiments of water generation system 100 for generating liquid water from a process gas containing water vapor. System 100 comprises a hygroscopic material that can be present in one or more sorption bodies or layers 118 configured to capture water vapor from a process gas during a water uptake, loading or sorption operational mode of the system. During a regeneration, release or desorption operational mode, a thermal portion or unit 110 is configured to directly and/or indirectly heat the hygroscopic material and transfer water vapor released therefrom to a regeneration fluid flowing in a regeneration flow path 140 during a release or desorption operational mode. The thermal portion or unit 110 can comprise glazing layer(s) 112, solar unit or photovoltaic layer 114 and/or interstitial layer(s) 116.

Water generation systems of the present technology can generate liquid water from a process gas containing water vapor, for example ambient air at atmospheric temperature and pressure. System 100 comprises a solar thermal portion or unit, for example configured as a top cover and/or glazing layer(s) 112 coupled to a housing 102 such that an outer top surface is exposed to the ambient environment to collect solar radiation. Furthermore, system 100 includes a solar power unit, power generation unit, or more particularly a photovoltaic (PV) panel or layer 114. In some embodiments, water generation system 100 can further comprise at least one interstitial layer (e.g., 116) below the top cover layer 112 for improving solar radiation collection. Solar units of the present technology can be configured to convert solar radiation impinging thereon into heat and/or electrical energy. Furthermore, a regeneration fluid flowing can receive heat from the solar unit during a release or desorption mode or cycle.

Water generation systems of the present technology can convert solar insolation to thermal energy by transferring energy from sunlight to a regeneration fluid or gas, a heat absorbing fluid or gas, or a “working” fluid or gas that flows through the water generation system, for example in a regeneration flow path. In some embodiments, the water generation system converts solar insolation to both thermal and electrical energy, for example via a solar unit including one or more glazing layer(s) and photovoltaic layer(s).

The top cover layer 112 can comprise an outer surface exposed to ambient air and an inner surface opposite from the outer surface. The top cover or glazing layer can include a transparent material (e.g., glass) allowing solar radiation to pass into the interior of the water generation system 100. In some embodiments, the top cover layer can comprise one or more photovoltaic panels including PV cells for converting solar insolation to electrical energy. Furthermore, one or more interstitial layers can comprise an assembly including one or more photovoltaic (PV) panels or layers for converting solar insolation to electrical energy, one or more glazing layers (e.g., transparent layers, glass layers) or a combination thereof. In some embodiments, optional interstitial glazing layers can be distinct layers from one or more photovoltaic layers (e.g., separated by a gap), such as depicted in FIG. 1 (i.e., interstitial glazing layer 116 is positioned above and spaced apart from photovoltaic layer 114). However, in other embodiments, an interstitial layer can be integrally formed or comprise both a glazing portion (e.g., glass) and a photovoltaic unit or portion (e.g., photovoltaic cells), in addition to other components (e.g., encapsulation materials, electrical wiring, and/or the like) such as depicted in FIG. 2A and FIG. 2B. In some embodiments, water generation systems of the present disclosure can comprise a photovoltaic panel or layer 114 below and spaced apart from top cover layer 112 without any intervening layer(s).

In some embodiments, the water generation systems can be configured as a solar glazed or unglazed thermal collector(s) to convert radiant solar energy into thermal energy, and in turn, heat the hygroscopic material and/or regeneration fluid. Furthermore, some water generation systems can include hybrid solar collectors, or photovoltaic thermal solar collectors that convert solar radiation into both thermal and electrical energy such that the generated heat is transferred to the hygroscopic material and/or regeneration fluid and the generated electricity powers the components of the water generations system (e.g., fan(s), compressor(s), controller(s) and/or the like).

In FIG. 1, FIG. 2A-B and FIG. 3A-B, the thermal unit 110 is a solar thermal desiccant unit comprising a hygroscopic material arranged in one or more porous hygroscopic or sorption layers 118 (distinct or separate sorption layers are indicated as 118a-b), for example as porous hygroscopic layers configured to capture water vapor from the process gas flowing therethrough during the loading operational mode. Furthermore, a regeneration fluid or gas accumulates heat and water vapor upon flowing through the sorption or hygroscopic layers during a release operational mode.

Water generation system 100 further comprises a hygroscopic material configured as a sorption unit, body or layer 118. The sorption unit, layer or body 118 can comprise a light absorbing material configured to absorb solar radiation, for example during daytime hours. In an embodiment, the sorption layer 118 comprises or is formed of a hygroscopic material, hygroscopic body, hygroscopic composite and/or hygroscopic assembly configured to capture (e.g., adsorb, absorb) water vapor from a process gas (e.g. ambient air at atmospheric pressure) upon flow across and/or therethrough, for example during a sorption cycle (e.g., nighttime hours). Furthermore, the sorption layer 118 can be configured to transfer water vapor heat and/or heat to a regeneration or working gas during an unloading, release or desorption operational cycle.

In many embodiments the sorption layer(s) (e.g., 118) comprise or are formed of a porous hygroscopic layer, material, composite, body or assembly configured to capture and release water vapor upon exposure to a process gas (e.g., ambient air) and can have various compositions and structures which will be described in more detail below. For ease of description, the following terms will be used to describe hygroscopic or water vapor sorption/desorption portions or layers within the water generation system, unless otherwise noted.

The term “hygroscopic media” or “hygroscopic material” is used herein to describe a functional material involved in absorption/adsorption and desorption of water.

The term “support media” or “support substrate” is used herein to describe a support structure that has a tuned or specified pore distribution to support a deliquescent salt or hygroscopic material, for example such that as the hygroscopic material gains water and transitions to a liquid state, the resulting capillary forces generated by the interaction of the liquid and the pore walls substantially retains the liquid in the pore structure.

The term “hygroscopic composite” or “composite material” is used herein to describe the combination of the support media and the hygroscopic media. The hygroscopic media is supported in and on the surfaces defined by the internal pore structure and external surface geometry of the support media.

The term “hygroscopic composite assembly” or “composite assembly” is used herein to describe the assembly, form, or structure created to hold the “hygroscopic composite” into a functional part that meets the physical criteria of the system including structural properties, pressure drop, flow paths, and thermal properties. The composite assembly can be a loose packed structure of the composite material held within a frame, or it can itself be a composite structure containing the composite material, a binder, and/or structural components that form a rigid self-supporting composite.

In various embodiments, the sorption layer can be configured as one or more porous hygroscopic body or layer, for example as a hygroscopic composite including a support substrate. The ‘porous’ or ‘porosity’ term used herein can describe a flow-through implementation, as opposed to flow-over or flat plate implementation of the sorption layer. While flow-over or flat plate implementations could be employed without departing from the scope of this invention, it can be preferable to keep the boundary layers small with a high degree of percolation for example as can be provided in porous flow-through bodies, units or layers. A porous hygroscopic material, composite, composite assembly or layer can be further configured to absorb thermal energy (e.g., radiative solar thermal energy) and release captured water vapor to a working or regeneration fluid, for example during a desorption/release operational mode or cycle. In one example, a hygroscopic material and/or composite can be arranged within a flow distributor, such as but not limited to a lattice structure, top and bottom rigid porous plates, inter-corrugated fluidic channels, interdigitated fluidic channels, and/or woven and fiber meshes to sustain back pressure and distribute the flow. A hygroscopic composite can be further configured as a composite assembly such that its structure provides the system with structural properties, pressure drop, flow paths, and/or thermal properties.

A sorption body or layer can be configured to receive heat from at least one thermal source, for example a regeneration gas, solar insolation, a photovoltaic cell, a heater, a heat exchanger, a condenser of a vapor-compression refrigeration cycle and/or the like. Furthermore, the regeneration fluid or gas can accumulate heat, and/or water vapor when comprising a hygroscopic material, upon flowing across or through the sorption layer. In FIG. 1, FIG. 2A-B and FIG. 3A-B, sorption layer 118 is positioned below and spaced apart from glazing layer 112 and interstitial photovoltaic layer 114, however other configurations are also possible.

FIG. 2A illustrates a block diagram of a water generation system 100 including a process flow path (indicated by short dashed lines) during a sorption, uptake or loading operational mode or cycle. As depicted in FIG. 2A, the process flow path (indicated by short dashed lines) can direct ambient air into system 100 via fan assembly 160. Process gas, for example ambient air, from outside system 100 can be transported into system 100 (e.g., via valve unit or assembly 190). In various embodiments, one or more filters can be provided to filter process gas (e.g., remove contaminants like dust and the like from ambient air) in advance of inputting into system 100. For example, a porous filter layer can be included as part of fan assembly 160. During a sorption or loading operational mode, ambient air can enter the system via a process inlet port. Upon entering system 100, process gas can be transported through thermal unit 110 along the process flow path. Process gas can then exit system 100, for example via fan assembly 160 and/or another system exhaust. In various embodiments, fan assembly 160 can be configured to adjust the flow rate of ambient air (as process gas and/or cooling fluid) into system 100.

FIG. 2B illustrates a block diagram of a water generation system including a regeneration flow path during a desorption, release or unloading operational mode or cycle. As depicted in FIG. 2B, a regeneration flow path (depicted in solid lines) can be entirely, or at least partially, closed-loop and can include multiple flow segments through system 100 including: a regeneration flow path segment within solar thermal unit 110 (e.g., during which the regeneration fluid uptakes heat and water vapor); a first or “hot-side” regeneration fluid flow segment 142 exiting thermal unit 110 and through recuperative heat exchange assembly 130 (e.g., being cooled so as to condense water vapor from the regeneration fluid); and, a second or “cold-side” regeneration fluid flow segment 144 through recuperative heat exchange assembly 130 (e.g., indicated by upward arrow after condensation of water vapor) and returning into thermal unit 110. During the unloading or regeneration operational mode, recuperative heat exchange assembly 130, a separate condenser, and/or a water storage reservoir can include a liquid water production outlet 180 configured to output liquid water produced by system 100.

FIG. 3A and FIG. 3B illustrate water generation system 100 having a low profile or compact water generation panel configuration. FIG. 3A depicts water generation system 100 including a process flow path (indicated by short dashed lines) during a sorption, uptake or loading operational mode or cycle. As depicted in FIG. 3A, the process flow path (indicated by short dashed lines) can direct ambient air into system 100 via fan assembly 160. Process gas, for example ambient air, from outside system 100 can be transported into solar thermal unit 110 (e.g., such that system 100 uptakes water vapor from the process gas upon flow through hygroscopic material bodies 118a and 118b) via valve assembly 190 that can include a sliding valve assembly. During a sorption or loading operational mode, ambient air can be transported along the process flow path such that 118a and 118b uptakes water vapor before exiting system 100, for example via fan assembly 160 and/or another system exhaust. In various embodiments, fan assembly 160 can be configured to adjust the flow rate of ambient air (as process gas and/or cooling fluid) into system 100.

FIG. 3B illustrates water generation system 100 having a compact or low-profile configuration including a regeneration flow path during a desorption, release or unloading operational mode or cycle. As depicted in FIG. 3B, a regeneration flow path (depicted in solid lines) can be entirely, or at least partially, closed-loop and can include multiple flow segments through system 100 including: a regeneration flow path segment within solar thermal unit 110 (e.g., during which the regeneration fluid uptakes heat and water vapor upon flow through hygroscopic material bodies 118a and 118b); a first or hot-side regeneration fluid flow segment 142 exiting thermal unit 110 and through recuperative heat exchange assembly 130 (e.g., being cooled so as to condense water vapor from the regeneration fluid); and, a second or cold-side regeneration fluid flow segment 144 through recuperative heat exchange assembly 130 (e.g., indicated by upward arrow after condensation of water vapor) and returning into thermal unit 110.

During the unloading or regeneration operational mode, recuperative heat exchange assembly 130 can be cooled by a cooling fluid (e.g., ambient air) directed in cooling flow path 146 including one or more cooling layers of recuperative heat exchange assembly 130. For example, cooling fluid inlet(s) 122 can direct ambient air into cooling flow path 146 (indicated by long dashed lines) at least partially defined by longitudinally extending heat exchange plates of recuperative heat exchange assembly 130. In various embodiments, cooling fluid (e.g., ambient air) flowing in a cooling flow path 146 can supplement cooling of the hot-side regeneration fluid by the cold-side regeneration fluid in the same cooling layers to drive condensation of water from the hot-side regeneration fluid flow. The cooling flow path 146 can be configured to direct ambient air in a direction at least partially counter to the flow direction of the hot-side regeneration fluid flow 142 in an adjacent layer before being exhausted to the outside environment (e.g., via cooling fluid outlet(s) 124).

Disclosed recuperative heat exchangers, or recuperators, can optimize a system's overall efficiency by cooling a high temperature incoming fluid or air stream to a temperature closer to a desired temperature via the transfer of thermal energy from a low temperature fluid or air stream. Disclosed recuperative heat exchangers allow for efficient transfer of heat from a hot-side to a cold-side flow or stream while maintaining isolation of the two flows or streams from each other. Disclosed compact recuperators can be desirable, especially for field deployable water generation systems, in order to reduce size and material costs of the system, all while providing high heat exchange effectiveness to maximize heat recuperation, and water production when used incorporated into a water generation system.

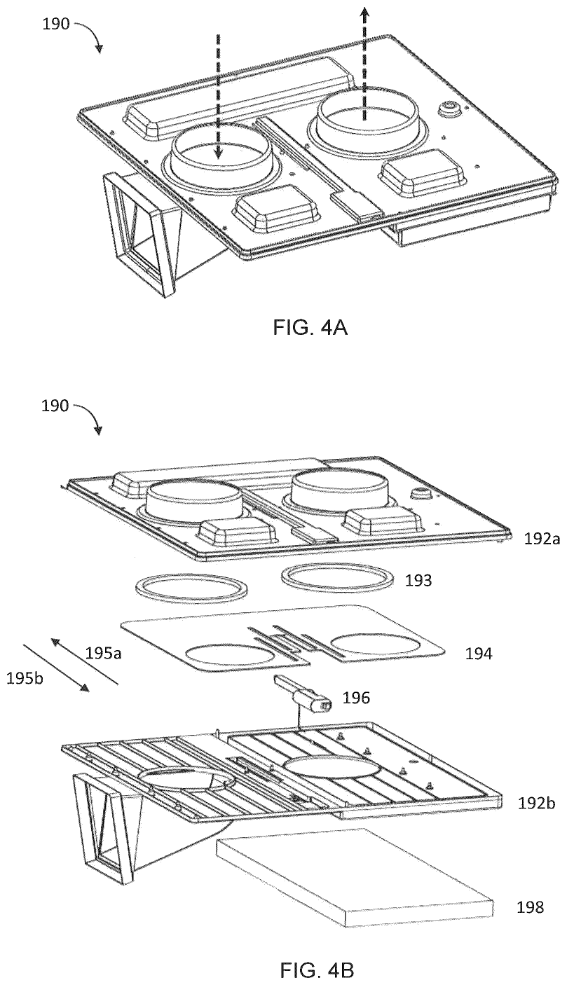

FIG. 4A illustrates one embodiment of a valve unit or valve assembly 190 including a sliding valve configuration or assembly, and FIG. 4B illustrates an exploded view of a valve assembly 190 including a sliding valve configuration or assembly. The valve unit or assembly 190 comprises a housing including upper housing 192a and lower housing 192b configured to define two flow channels having a flow channel axis (indicated by short dashed lines in FIG. 4A). Slide plate 194 is positioned in housing 192a-b and is configured to laterally or transversely to the flow channel axis between a first or open position (indicated by arrow 195a) and a second, or closed, position (indicated by arrow 195b). As depicted, housing 192a comprises annular surfaces to define flow channels and gaskets 193 positioned between the annular surface of the housing and the slide plate to manage and direct flow, however other configurations are also possible. In various embodiments, one or more filters (e.g., filter 198) can be provided to filter process gas so as to remove contaminants like dust and the like in advance of inputting into system 100.

An actuator (e.g., linear actuator 196) can be configured to move or reciprocate the slide plate 194 between the first position and the second position. In a first or opened position, the slide plate 194 can move in a direction indicated by 195a such that fluid can freely enter and exit the flow path, while in a closed position the slide plate 194 is moved in a direction indicated by 195b such that the slide plate 194 seals or closes the flow channels in the second position. As such, actuator 196 can transition the slide plate 194 along a plane perpendicular to the direction of flow. Slide plate 194 can contact one or more members (e.g., two elastomer gaskets 193) to improve and/or form a seal, for example polymeric components or rings, compressible lips, or other surface features that sealing flow between or across a plurality of surfaces.

In the first or opened position, a seal around the perimeter of holes in slide plate 194 allows flow to traverse slide plate 194, or more particularly, into and out of thermal unit 110 during a loading mode or cycle such as depicted in FIG. 3A. In the second or closed position, the seal acts on unperforated or planar sections of slide plate 194 to prevent flow into or out of thermal unit 110 during a release mode or cycle, such as depicted in FIG. 3B.

In an exemplary operational method, slide plate 194 moves laterally into the first position to allow process gas (e.g., ambient air) flow in the process flow path through the thermal unit 110 via inlet flow channel (indicated by upward short dashed arrow) and outlet flow channel (indicated by downward short dashed arrow) during the loading or uptake mode. During the unloading or regeneration mode, slide plate 194 moves laterally into the second position to seal the solar thermal unit to allow regeneration fluid flow in a closed loop path.

System 100 can include a controller (e.g., controller 170) to detect faults and/or leaks associated with valve(s) e.g., valve assembly 190. For example, controller (e.g., 170) can detect an abnormal variation or difference in relative humidity and/or temperature via sensor(s) in the process flow path and/or regeneration flow path. If the variation or difference in relative humidity and/or temperature is above a predetermined threshold, controller can set the system in a fault or maintenance mode, or attempt to resolve the fault (e.g., cycle the valve between open/closed positions). For example, if valve assembly 190 is not sealed or leaks are present during the unloading mode, sensor(s) in the process air flow path (e.g., positioned outside of solar thermal unit 110, near fan assembly 160, or below valve assembly 190) can be exposed to higher temperatures and/or humidities of the regeneration fluid flowing in the regeneration flow path.

As another example, controller (e.g., 170) can detect an abnormal variation or difference current or power draw from one or more fan(s) flowing process gas in the process flow path and/or regeneration gas in the regeneration flow path. If the variation or difference in current or power draw from one or more fan(s) is above a predetermined threshold, controller can set the system in a fault or maintenance mode, or attempt to resolve the fault (e.g., cycle the valve between open/closed positions). In a faulty open position or in a faulty closed position (e.g., leaky or unsealed state), a fan (e.g., fan 160) sucking air from a small volume can result in formation of negative pressure causing the fan to draw more than normal current to reach its setpoint (e.g., revolution per minute (RPM)).

FIG. 4A and FIG. 4B depict valve unit or assembly 190 comprising a sliding valve assembly, however any desirable number or type of valves, separately or in combination, can be used to manage flow through system 100. Furthermore, system 100 can include one or more valves or mechanisms for flow bypass and/or alternative fluid passageway configurations within the system, as well as to provide a system-wide or total ingress protection. The system can include valves operating under any number of mechanisms including but not limited to a sliding valve, an inflatable valve, an iris valve, a butterfly valve, a poppet valve, an actuated valve, a passive or active flow directing or restricting valve members and/or the like.

System 100 can include one or more blowers or fans (e.g., regeneration fan 147) to increase or adjust the flow rate of the working fluid in the closed-loop regeneration flow pathway through thermal unit 110 and/or recuperative heat exchange assembly 130. During an unloading or release cycle, the regeneration fluid can accumulate both heat and water vapor upon flowing through solar thermal unit 110 and efficiently release the accumulated water vapor upon flowing through recuperative heat exchange assembly 130.

In some embodiments, recuperative heat exchange assembly 130 can be formed as a monolithic structure, such that at least some structural components are formed or molded together, for example during the same manufacturing and/or assembly operation to form recuperative heat exchange assembly 130 from stamped sheet metal, stainless steel, plastic, or other materials optionally coated with water safe coatings. For example, a recuperative heat exchange assembly 130 can be formed as a monolithic structure comprising heat exchange surfaces or plates bonded via brazing, gasketing, adhesive, and/or welding. In another example, a recuperative heat exchange assembly 130 can be formed as a monolithic structure thermoformed from thermoplastic materials.

In embodiments where a recuperative heat exchange assembly is formed as a monolith, one or more benefits and advantages can be provided. For example, a monolithic recuperative heat exchange assembly can provide a low profile or compact system. Furthermore, a monolithic recuperative heat exchange assembly can offer a lower manufacturing cost and/or be easily replaced in the field. Additionally, a monolithic configuration can reduce the number of portions or components of the system to simplify the manufacture, maintenance, complexity and/or other aspects associated with making and using the system. In some embodiments, a recuperative heat exchange assembly functions as a condenser. However, alternative implementations may include a separate condenser assembly (e.g., for further driving water condensation from the regeneration fluid and/or produced liquid water storage) coupled to a recuperative heat exchange assembly.

As depicted in FIG. 1, FIG. 2A-B and FIG. 3A-B, water generation system 100 comprises a recuperative heat exchange assembly 130 for increasing the relative humidity and/or the partial pressure of water vapor in the regeneration fluid to drive condensation of water vapor from the regeneration gas during the release or desorption operational mode or cycle. The recuperative heat exchange assembly 130 can be configured to reduce the temperature of at least a portion of the regeneration fluid by rejecting heat to ambient environment, another cooler portion of the regeneration fluid and/or another heat absorbing fluid, e.g., a refrigerant. The recuperative heat exchange assembly 130 can be configured as a single unit provided as an assembly of components or be a component of a heat transfer cycle or system.

In one example, recuperative heat exchange assembly 130 provides a high surface area for heat transfer to drive condensation of water vapor from the regeneration fluid, for example with minimal pressure drop upon flow across or therethrough. In one example, recuperative heat exchange assembly 130 can comprise a heat sink and/or heat transfer surfaces (e.g., heat dissipating surfaces, fins, ridges, ribs, protrusions, clamshell, passive heat sink and/or the like) to reject heat from the regeneration gas to the ambient environment. In some embodiments, recuperative heat exchange assembly 130 can form an outer portion of the system housing so as to reject heat to the ambient environment. In other embodiments, the recuperative heat exchange assembly 130 can be located entirely within a system housing.

In addition to heat dissipating features, heat exhaust approaches and/or active or passive flow directing elements, additional components can be included to improve water production efficiency, for example, to improve the efficiency of liquid water condensation for the production of water from the regeneration flow path(s). This can be advantageous, for example when the system is in a high system water content state such that the hygroscopic materials of the system and/or the regeneration fluid are water rich (e.g., high absolute humidity, high equilibrated humidity or equilibrated water content of hygroscopic materials) to balance the efficiency of water release relative to water uptake or loading cycles. In some operational conditions or system states, water condensation can limit water production rather than water uptake or other system functions being limiting. In such states, it may be preferable to boost or improve the systems water condensation efficiency, for example by providing additional power to recuperative heat exchange assembly 130 (e.g., increase power to fan 160 for ambient air cooling via cooling fluid 146).

The recuperative heat exchange assembly 130 can be configured as an air-cooled component (e.g., formed from polymeric, plastic and/or metallic materials) that can condense water from the regeneration fluid of the regeneration flow path(s). The system can power (e.g., via onboard PV or battery power) blower(s) or fan(s) (e.g., fan 160) to flow ambient air over and/or through the recuperative heat exchange assembly 130, thereby improving heat transfer, water condensation efficiency and therefore water production. In such implementations, ambient air cools (via heat transfer across and/or through surfaces of the recuperative heat exchange assembly 130) the hot-side regeneration fluid flow 142 through recuperative heat exchange assembly 130 in order to extract water and excess heat is exhausted to the outside environment.

Recuperative heat exchange assemblies of the present disclosure can be simple in design and easy to manufacture. Furthermore, low heat transfer performance due to environmental and/or system conditions can limit water production rates of the system. In some implementations, water generation systems can operate in a hybrid or dynamic manner wherein an operational setpoint is adjusted (e.g., power distribution to fan 160 for ambient air cooling and/or regeneration fan 147 via controller 170) based on a system operational state (e.g., system power state, system water content) and/or an environmental condition (e.g., ambient relative humidity, ambient temperature) to improve water production performance. In particular, recuperative heat exchangers of the present technology can be configured to increase the relative humidity (% RH) in at least a segment of the regeneration flow path to drive condensation of water vapor therefrom. Furthermore, a recuperative heat exchange assembly can be configured to increase the relative humidity in at least one segment of the regeneration flow path to drive condensation of water vapor therefrom, thereby improving liquid water production during a release operational mode or cycle.

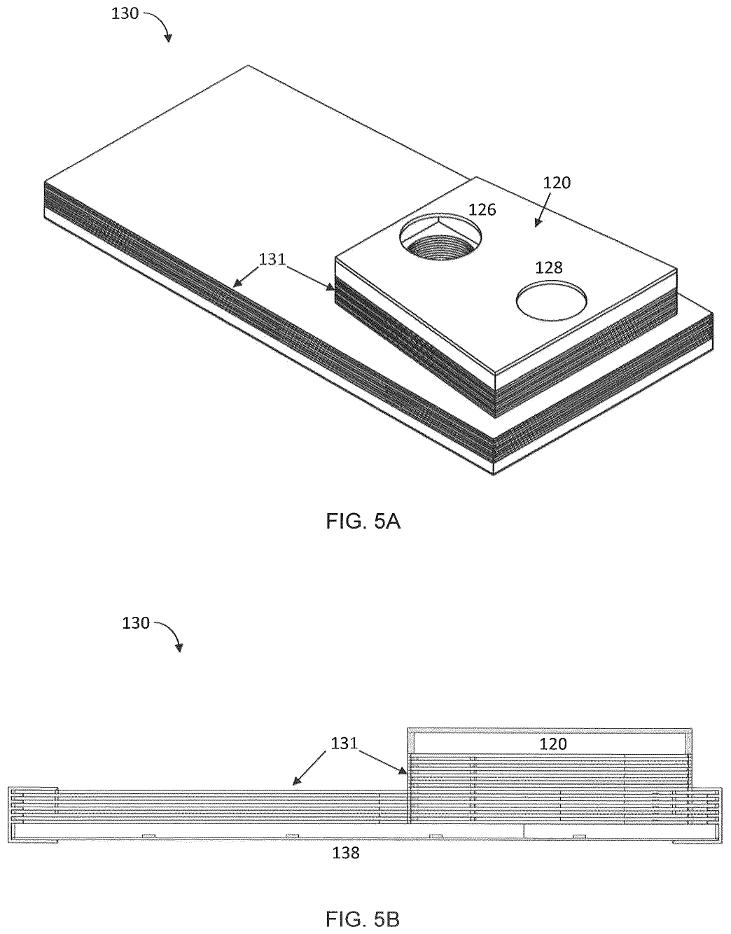

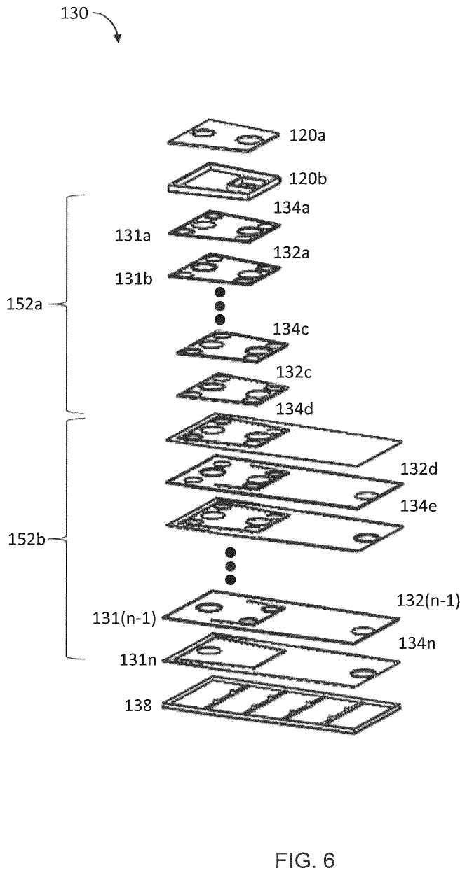

As depicted in FIG. 5A-9, recuperative heat exchange assembly 130 comprises a plurality of longitudinally extending heat exchange surfaces, elements or plates 131, or individually indicated as 131a-n, arranged in a spaced relation (e.g., stacked, vertically spaced and/or the like) to at least partially define a plurality of flow channels or layers (e.g., parallel flow layers, alternating hot-side/cold-side flow layers and/or the like). For example, longitudinally extending heat exchange plates 131 can at least partially define first or hot-side regeneration flow layers 132 (individually indicated as 132a-n) alternating between cooling flow layers 134 (individually indicated as 134a-n). A hot-side regeneration fluid flow layer 132 at a high temperature (e.g., greater than 40° C., greater than 60° C., greater than 70° C., between 40-80° C.) can direct a first or hot-side regeneration fluid flow 142 in a direction at least partially counter to a flow direction of a second or cold-side regeneration fluid flow 144 at a lower temperature (e.g., less than 70° C., less than 60° C., less than 40° C., between 20-60° C.) in an adjacent cooling flow layer 134 to establish a counter-flow heat exchange relation therebetween.

The heat exchange layers or passes 132, 134 can be stacked both above and below one another in an alternating manner to form multiple parallel flow paths for each fluid flow, with heat exchange surfaces (e.g., heat exchange plates) located between hot and cold flow segments or streams. In some embodiments, the heat exchange plates and/or surfaces can be composed of or comprise a polymeric material (e.g., thin plastic plates). Furthermore, some heat exchange assemblies can be entirely made of plastic or polymeric materials. In other embodiments, the heat exchange surfaces can be composed of or comprise metallic material (e.g., thin aluminum plate). In yet other embodiments, the heat exchange surfaces can be composed of or comprise a combination of polymeric material(s) and metallic material(s). The surface area of the plates 131 and/or heat exchange surfaces can be maximized in order to maximize the heat transfer capability. The orientation of the fluid flows through the recuperative heat exchange assembly 130 can be single or multiple pass counter-flow, partially counter flow, or crossflow for applications requiring maximum heat exchange effectiveness for a desired system dimension.

As depicted in FIGS. 2B and 3B, recuperative heat exchange assembly 130 comprises a recuperator inlet 126 configured to receive a first regeneration fluid flow 142 (e.g., hot-side regeneration fluid flow output from the solar thermal unit 110) of the regeneration flow path 140. The recuperative heat exchange assembly 130 can further comprise a recuperator outlet 128 configured to output a second regeneration fluid flow 144 (e.g., cold-side regeneration fluid flow input to solar thermal unit 110) of the regeneration flow path 140. The regeneration fluid flows in a closed-loop regeneration flow path 140 including the first regeneration fluid flow 142 (e.g., through a plurality of hot-side passes or layers 132 and the second regeneration fluid flow 144 through a plurality of cold-side passes or cooling layers 134). The system can be configured such that the first regeneration fluid flow 142 in one of the hot-side layers 132 flows in a direction at least partially counter to a flow direction of the second regeneration fluid flow 144 in an immediately adjacent cooling layer 134. Furthermore, the system can be configured such that the first regeneration fluid flow 142 in one of the hot-side layers 132 flows a direction at least partially counter to a flow direction of cooling fluid flow (e.g., ambient air) 146 in an immediately adjacent cooling layer 134.

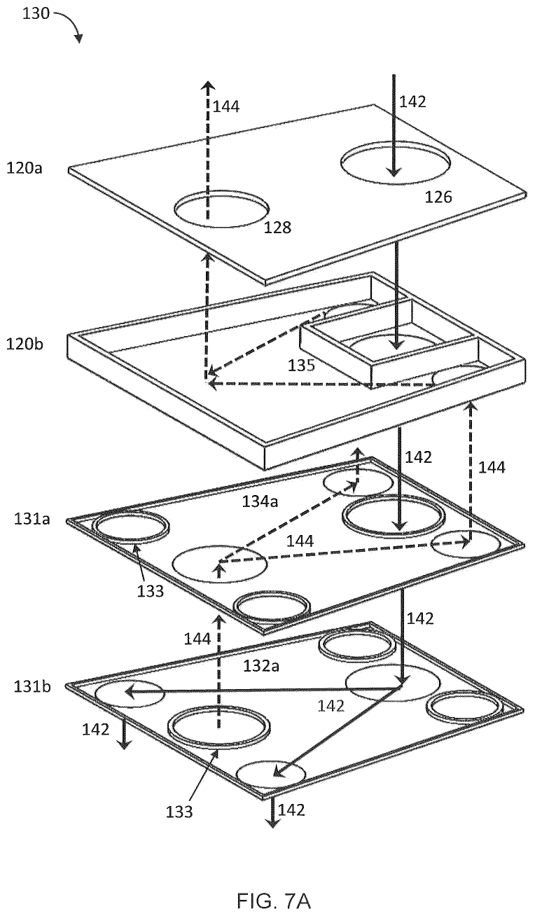

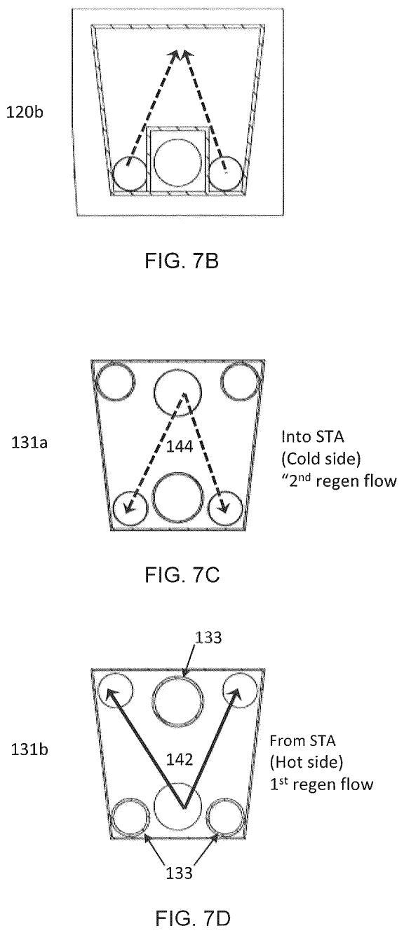

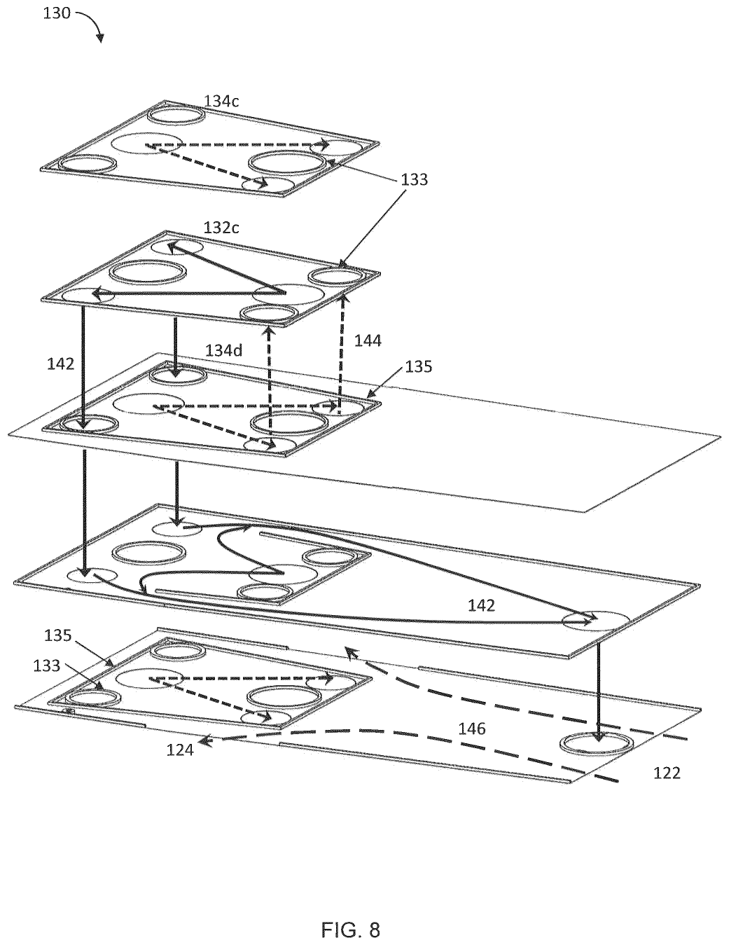

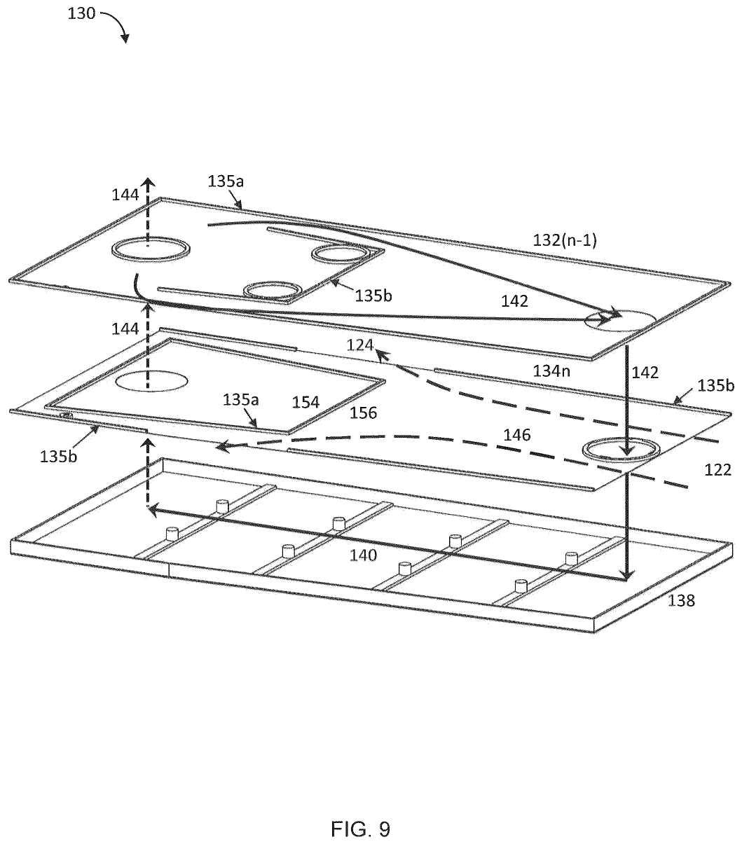

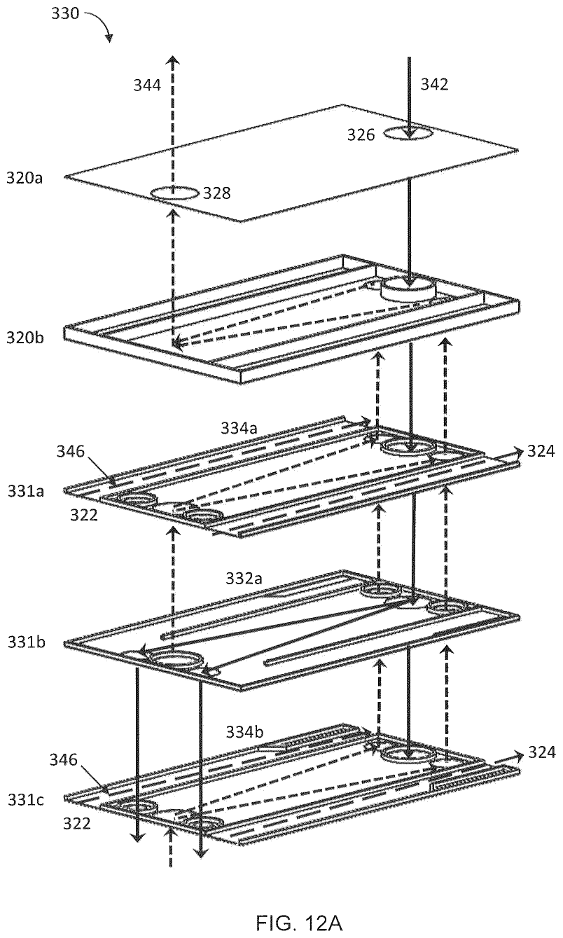

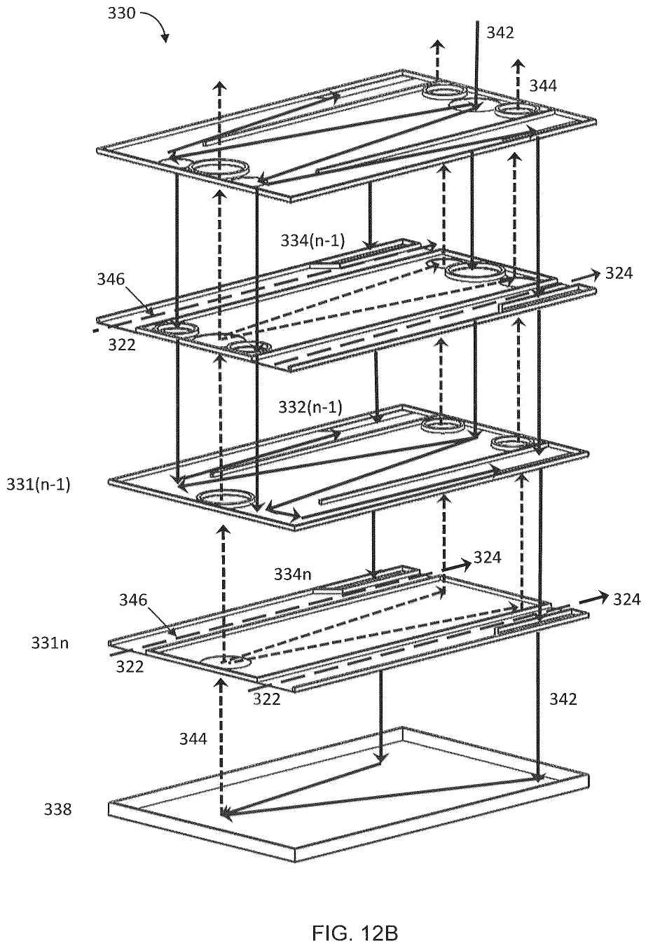

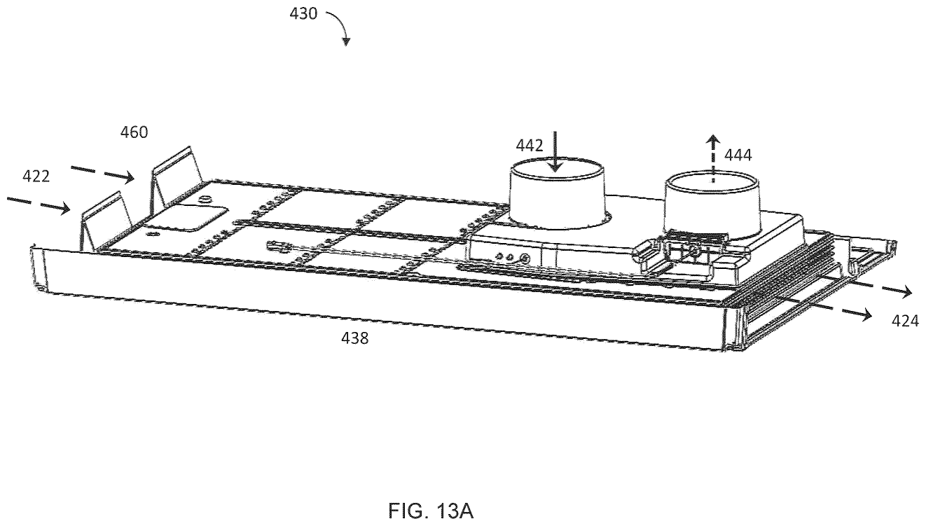

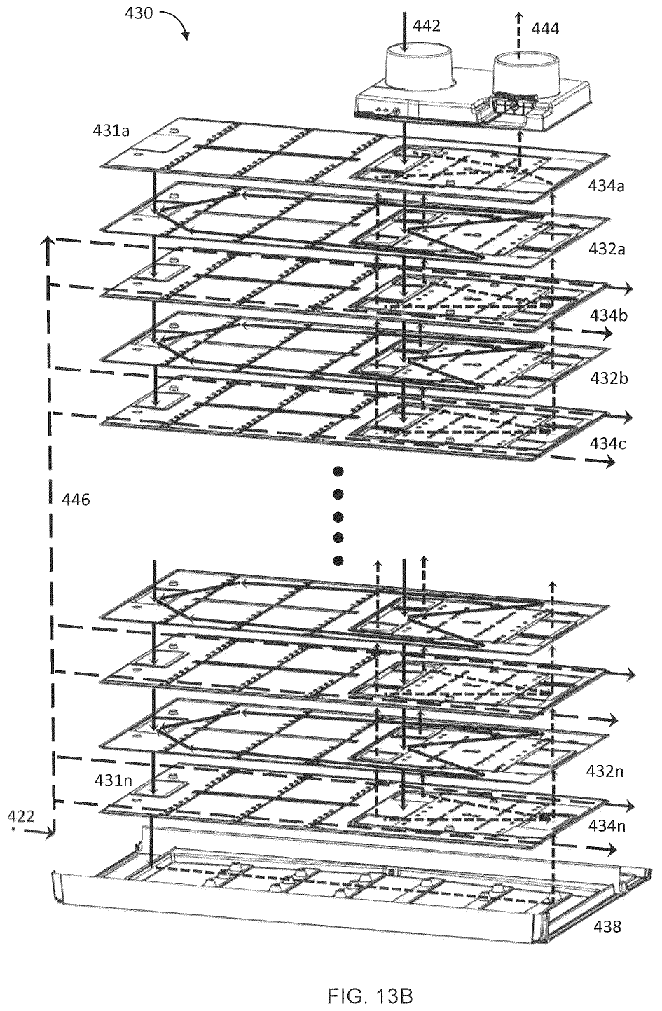

For ease of description, the first or hot-side regeneration fluid flow (e.g., 142, 242, 342, 442) of regeneration flow path (e.g., 140, 240, 340, 440) is depicted in solid arrows, the second or cold-side regeneration fluid flow (e.g., 144, 244, 344, 444) of regeneration flow path is depicted in short dashed arrows and cooling fluid flow (e.g., 146, 246, 346, 446) is depicted in long dashed arrows FIG. 7A-D, FIG. 8-9, FIG. 12A-B and FIG. 13A-B.

In various embodiments, spacers 133 are located between adjacent heat exchange plates 131 to set a spacing relation (e.g., Z-direction or “vertical” height of heat transfer layers) therebetween, function for flow direction or interaction, and/or to define intervening passages between heat exchange plates. Spacers can be configured to separate flow paths (e.g., separate cold-side regeneration fluid flow from cooling flow path in a cooling layer, separate cold-side regeneration fluid flow from hot-side regeneration fluid flow), and can also affect or provide flow interaction features (e.g. vortex shedding, forced area interaction act within a flow path). Spacers can comprise or be composed of insulative materials and/or be produced via stamping or forming raised spacer sections and providing an air gap.

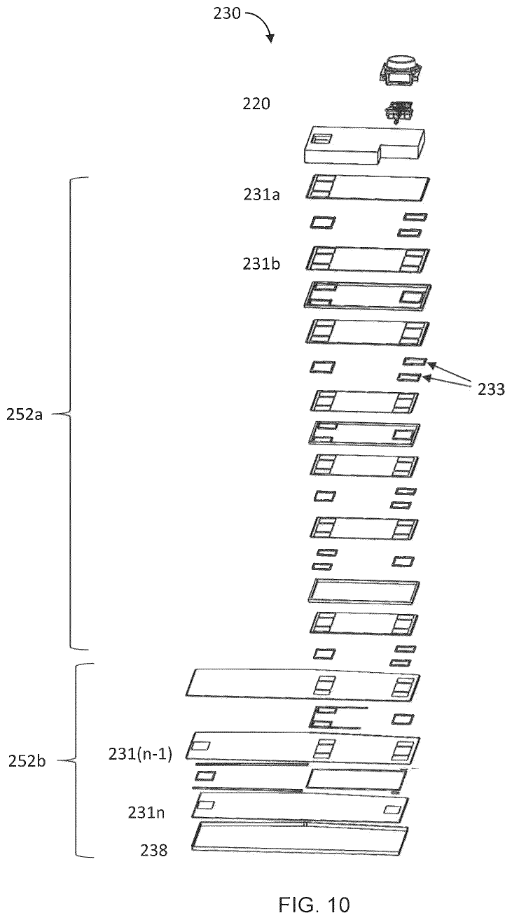

Spacers can be in any desirable shape to maximize heat transfer with minimal pressure drop and/or provide compact system dimensions, for example, in an annular form such as depicted as 133 in FIG. 7-9, rectangular form such as depicted as 233 in FIG. 10, or other derivatives or combinations thereof.

In many embodiments, a cooling fluid (e.g., ambient air) flows in a cooling flow path 146 including at least one of the cooling layers 134. For example, cooling fluid inlet(s) 122 are configured to direct ambient air into cooling flow path 146 at least partially defined by at least one of the plurality of longitudinally extending heat exchange plates 131. In various embodiments, cooling fluid (e.g., ambient air) flowing in a cooling flow path 146 can supplement cooling of the hot-side regeneration fluid by the cold-side regeneration fluid in the same cooling layers to drive condensation of water from the hot-side regeneration fluid flow. The cooling flow path 146 can be configured to direct ambient air in a direction at least partially counter to the flow direction of the hot-side regeneration fluid flow 142 in an adjacent layer before being exhausted via cooling fluid outlet(s) 124, or more particularly, exhausted to outside environment external to system.

The system can comprise a plenum 120 for directing regeneration fluid into and/or out from recuperative heat exchange assembly 130. In one example, a recuperative heat exchanger or thermal unit plenum 120a-b comprises recuperator inlet 126 configured to input the first regeneration fluid flow 142 into the recuperative heat exchange assembly 130. Furthermore, plenum 120 comprises recuperator outlet 128 configured to output the second regeneration fluid flow 144 from the recuperative heat exchange assembly 130. In one example, plenum 120 (e.g., lower plenum assembly 120b) comprises a flow divider 135 separating the first regeneration fluid flow 142 and the second regeneration fluid flow 144.

Systems of the present technology can include one or more blowers or fans (e.g., regeneration fan 147) to increase or adjust the flow rate of the regeneration fluid in the closed-loop regeneration flow path 140. Furthermore, controller 170 can be configured to adjust the flow rate of the regeneration fluid in the closed-loop regeneration flow path 140 during the release mode or cycle of a water generation system. During a release operational mode, the regeneration fluid can accumulate both heat and water vapor upon flowing through the hygroscopic material in sorption layer 118 and efficiently release the accumulated water vapor upon flowing through the recuperative heat exchange assembly 130 and/or a distinct or separate condenser (if present). A circulator, blower or fan (e.g., regeneration fan 147) can be seated in a portion of the recuperative heat exchange assembly 130 to adjust the flow rate of the regeneration fluid during the release mode. Furthermore, the one or more removable fan cartridges can be configured to be easily accessible for reversible replacement, for example via an access panel or lateral panel of the system. Including removable fan cartridges may be preferable to improve serviceability of the system. In one non-limiting example, controller 170 can be configured to adjust the amount of electrical energy directed to the fan assembly 160 and/or the regeneration fan 147 based on: an environmental condition, a system power state, a system water content, a system temperature, a heat transfer effectiveness, a cooling effectiveness, a temperature difference of the system, a moisture difference of the system, or combinations thereof.

In one illustrative example, controller 170 can be configured to adjust the amount of electrical energy directed to the fan assembly 160 and/or the regeneration fan 147 if the temperature difference between hot-side regeneration flow and cold-side regeneration flow drops below 20° C., for example the amount of electrical energy directed to the cooling fan assembly 160 can be increased to improve cooling of the hot-side regeneration fluid. As another illustrative example, controller 170 can be configured to reduce the amount of electrical energy directed to the regeneration fan 147 i.e., reduce the regeneration flow speed if a temperature output from the thermal unit is below a predetermined threshold to increase the effectiveness of the recuperative heat exchange.

In an embodiment, recuperative heat exchange assembly 130 comprises a return plenum 138 for collecting water condensed from the regeneration fluid and to direct or return regeneration fluid in the regeneration flow path 140 into the second regeneration fluid flow 144 in advance of recirculation into thermal unit 110. As depicted in FIG. 9, the lowest or final cooling layer 134n comprises a passage directing the hot-side regeneration fluid flow 142 into plenum 138 and a passage to return the regeneration fluid into the cold-side regeneration fluid flow 144. The return plenum 138 can be configured to collect or store at least a portion of water condensed form regeneration fluid and can include a liquid water production outlet (e.g., 180).

In some embodiments, the heat exchange plate(s) 131 comprises flow divider(s), partition(s) or spacer(s) (e.g., 135) that can be configured as continuous flow directing element(s) (e.g., 135a) or discontinuous flow directing element(s) (e.g., 135b) supported on a surface of a heat exchange surface to define at least a portion of the regeneration flow path 140 and/or the cooling flow path 146. Furthermore, spacers 135 can be located at a perimeter location (e.g., spacer 135b of layer 134n in FIG. 9) or an inner location (e.g., spacer 135a of layer 134n in FIG. 9). In one example where a cooling layer is a dual flow cooling layer (e.g., 134d-e), partitions, dividers or spacers (e.g., 135) can define a regeneration fluid channel or section 154 directing the second regeneration fluid flow 144 therethrough, and a cooling fluid channel or section 156 directing the cooling fluid flow 146 therethrough. Flow-direction and interaction features (e.g., 133, 135) can provide multiple functions including separating flow paths, direct flow, improve flow interaction, improve heat transfer, provide structural support to the heat exchange assembly and/or the like.

In some embodiments, heat exchange plate(s) comprise an opening or passage proximate a first edge of the plate and an opening or passage proximate a second edge of the plate opposite from the first edge of the plate, for example such as depicted in FIG. 5A-9. Furthermore, a heat exchange plate can comprise a single opening or passage, towards a first side of the plate and at least two openings or passages at an opposing edge of the plate, so as to reduce the pressure drop therethrough. Openings, passages, and/or baffling at or between layers can be arranged or configured for parallel flow, crossflow, or counter flow heat exchange between layers and/or plates.

The recuperative heat exchange assembly 130 depicted in FIG. 5A-9 comprises a sectional flow architecture including a first or upper dual-flow section 152a comprising alternating layers 132 of the first or hot-side regeneration fluid flow 142 and cooling flow layers 134 including the second regeneration fluid flow 144 for recuperative heat exchange. The sectional flow architecture further comprises a second or lower tri-flow section 152b comprising alternating layers of the first or hot-side regeneration fluid flow 142 and dual cooling flow layers 134 including the second or cold-side regeneration fluid flow 144 and the cooling fluid flow 146 for both recuperative heat exchange and condensation with ambient air cooling. However, other flow architectures are also possible to maximize heat exchange efficiency, in particular to maximize water production.

In various embodiments, the recuperative heat exchanger flow architecture is configured for high efficiency heat transfer between adjacent layers while also allowing for high flow rates with minimal pressure drop. Furthermore, the flow architecture can include any desirable or suitable number and configuration of layers, spacers, dividers, separators or other flow directing structures or devices to improve heat transfer at a high regeneration gas flux and low pressure drop. For example, various configurations of the water generation system can be provided to maintain a gas flux through the system greater than 30 cubic feet per minute (CFM)/m², greater than 50 CFM/m², greater than 100 CFM/m², or greater than 200 CFM/m². In some embodiments, configurations of a water generation system can be provided to maintain a gas flux through the system between 25-75 CFM/m², 30-50 CFM/m² or 50-70 CFM/m². Furthermore, the recuperative heat exchange assembly can be configured to maintain a regeneration gas flux in the regeneration flow path greater than 30 CFM and a pressure drop less than 0.5 inches water.

Furthermore, a temperature difference between the regeneration fluid input to the recuperative heat exchanger and the regeneration fluid output from the recuperative heat exchanger can be less than 40° C. In one non-limiting illustrative example, a recuperative heat exchanger can be operated with a temperature difference of 30° C. between the regeneration fluid input to the recuperative heat exchanger and the regeneration fluid output from the recuperative heat exchanger such that the regeneration fluid input to the recuperative heat exchanger is cooled by approximately while the regeneration fluid output from the recuperative heat exchanger is heated by approximately 20° C. (e.g., at a 60% effective recuperator design).

Additional illustrative examples of recuperative heat exchangers and flow architectures, and in some cases water generation systems, will be described below. Unless otherwise specified below, the numerical indicators used to refer to components in FIGS. 10-15E are similar to those used to refer to components or features in FIGS. 1-9 above, except that the index has been incremented by 100.

FIG. 10 illustrates an exploded view of a recuperative heat exchange assembly 230 comprising rectangular layers and plates with rectangular shaped layer-to-layer passages that can be simple to manufacture. These rectangular openings can better utilize the heat transfer area of the plates in a rectangular heat exchanger layout and minimize unused heat exchanger area. Spacers between layers, baffles and/or flow dividers can be accomplished in the plates themselves via stamped, formed (e.g., thermoformed) and/or molded features. The recuperative heat exchange assembly 230 also comprises a sectional flow architecture including a first or upper dual-flow section 252a of alternating layers of hot-side regeneration fluid flow and cooling flow layers including the second regeneration fluid flow. Furthermore, a second or lower tri-flow section 252b comprises alternating layers of hot-side regeneration fluid flow and dual cooling flow layers including cold-side regeneration fluid flow and a cooling fluid flow (e.g., ambient air) for condensation of water from the regeneration fluid.

Recuperative heat exchangers of the present technology can be designed to integrate both 1) a recuperation function (e.g., counter-flow heat exchange) and 2) the transfer or flow of recuperated regeneration fluid (e.g., hot-side regeneration fluid flow 142 subsequent to transfer of heat to cold-side regeneration fluid flow 144) toward ambient air cooling in a single flow path approach wherein the condenser layers (e.g., lower layers like 152b) include recuperation layers. In other recuperative heat exchangers, the recuperative function (i.e., cross flow heat exchange) can occur sequentially with respect to condensation (e.g., recuperative heat exchange, followed by collection, followed by condensation). As such, recuperative heat exchange approaches of the present technology have the advantage in that the condensation layer(s) (e.g., lower layers) allow for continued recuperation while at the same time collecting and routing fluid flow for ambient air-cooled heat exchange. Furthermore, recuperative heat exchangers of the present technology can integrate ambient air cooling (e.g., via ambient air flow from external environment that can also be a process gas from water vapor is absorbed for water generation) and recuperative cooling in a layered flow architecture having collection or manifolding of flow within the layers (e.g., enabled by alternating spacers or flow directing elements) as opposed to collecting flow externally via a boxed or separate structure, flow rerouting and/or the like.

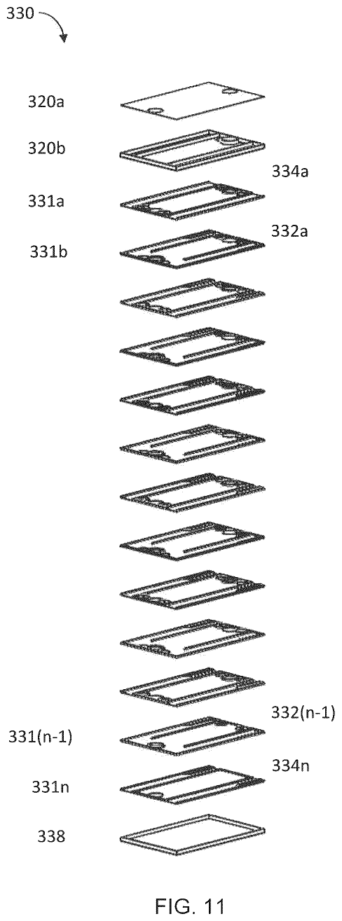

FIG. 11, FIG. 12A and FIG. 12B illustrate a recuperative heat exchange assembly 330 comprising a tri-flow architecture including alternating layers 332 of hot-side regeneration fluid flow 342 and cooling flow layers 334 including both cold-side regeneration fluid flow 344 and cooling fluid flow 346 (e.g., ambient air). This embodiment provides a uniform distribution of plate designs, and the ability to tune the ratio of hot-side regeneration fluid flow (e.g., 142) to cold-side regeneration fluid flow (e.g., 144) heat exchange relative to the ratio of hot-side regeneration fluid flow (e.g., 142) to ambient air cooling flow (e.g., 146) heat exchange by adjusting the ratio of heat exchange surface areas of the respective layers and fluid flow therethrough.

FIG. 13A illustrates a side perspective view of a compact recuperative heat exchange assembly 430, and FIG. 13B illustrates an exploded view of a compact recuperative heat exchange assembly 430 comprising longitudinally extending heat exchange surfaces 431 above plenum assembly 438. Various water generation systems (e.g., water generation system 100 of FIG. 3A-B) can comprise compact recuperative heat exchange assembly 430. The following description of compact recuperative heat exchange assembly 430 can correspond to operation of compact water generation system 100 of FIG. 3B including compact recuperative heat exchange assembly 430 during a desorption, release or unloading operational mode or cycle.

As depicted in FIG. 13A and FIG. 13B, recuperative heat exchange assembly 430 comprises a low profile or compact monolithic stack flow architecture including alternating layers 432 (individually indicated as 432a-n) of the first or hot-side regeneration fluid flow 442 and cooling flow layers 434 (individually indicated as 434a-n) including the second regeneration fluid flow 444 for recuperative heat exchange. The alternating layers of the first or hot-side regeneration fluid flow 442 and dual cooling flow layers 434 including the second or cold-side regeneration fluid flow 444 and cooling flow path 446 for both recuperative heat exchange and condensation with ambient air cooling. However, other flow architectures are also possible to maximize heat exchange efficiency, in particular to maximize water production.

Plenum assembly 438 can be configured to return regeneration fluid in the regeneration flow path from the hot-side regeneration fluid flow 442 into the cold-side regeneration fluid flow 444 and to collect water condensed from the regeneration fluid. Furthermore, when integrated or incorporated with a water generations system (such as depicted in FIG. 3A-B), plenum assembly 438 can be configured as a backsheet, an outermost layer or outer housing member of the water generation system (e.g., system 100 of FIG. 3A-B) so as to improve heat rejection to the ambient environment and/or reduce number of system components and cost.

During an unloading or regeneration operational mode, recuperative heat exchange assembly 430 can be cooled by a cooling fluid (e.g., ambient air) directed in a cooling flow path 446 including one or more cooling layers of recuperative heat exchange assembly 430. For example, ambient air can be directed (e.g., via fan assembly 460) into cooling flow path 446 at least partially defined by longitudinally extending heat exchange plates of recuperative heat exchange assembly 430. In various embodiments, cooling fluid (e.g., ambient air) flowing in a cooling flow path 446 can supplement cooling of the hot-side regeneration fluid by the cold-side regeneration fluid in the same cooling layers to drive condensation of water from the hot-side regeneration fluid flow. The cooling flow path 446 can be configured to direct ambient air in a direction at least partially counter to the flow direction of the hot-side regeneration fluid flow 442 in an adjacent layer before being exhausted to the outside environment.

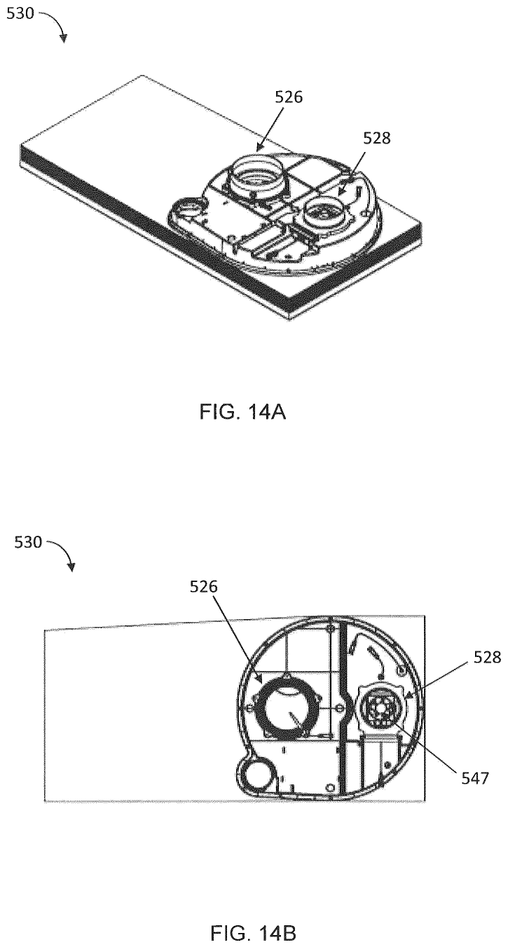

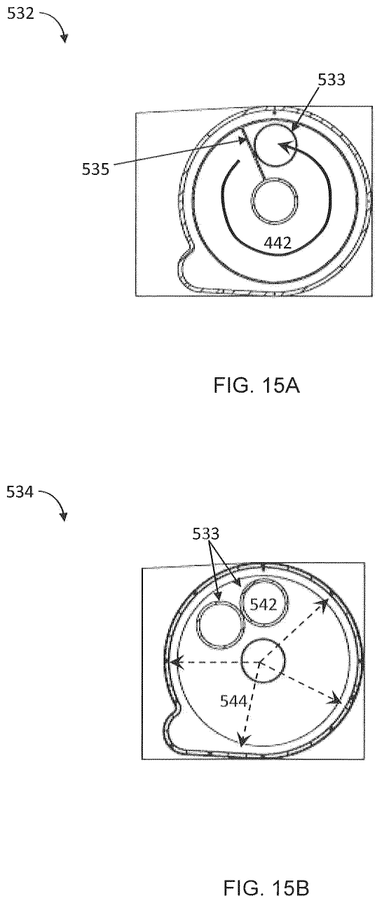

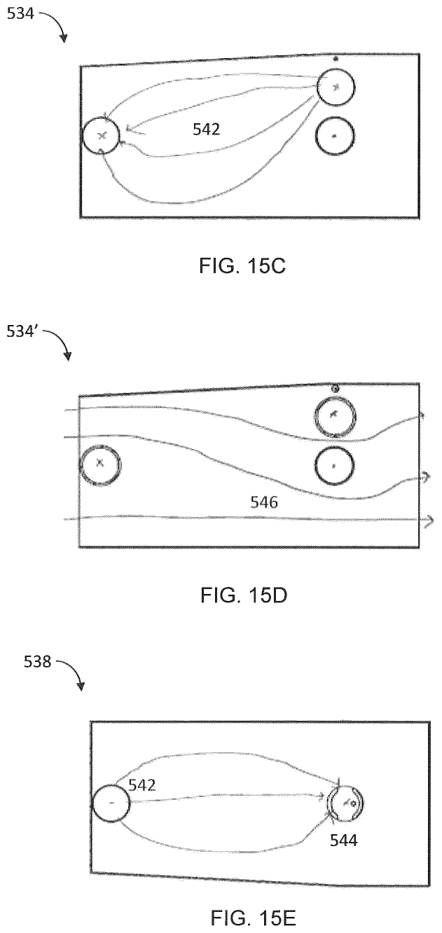

FIG. 14A-B and FIG. 15A-E illustrate a recuperative heat exchange assembly comprising a separate, distinct or stacked dual flow-dual flow architecture. A stacked dual flow-dual flow embodiment may provide advantages in matching cooling flow cross sectional areas with other mating components, and/or by taking advantage of enclosure volume that does not experience cooling flow by providing dedicated hot-side regeneration fluid flow 542 to cold-side regeneration fluid flow 544 heat exchange components within the assembly. The embodiment depicted in FIG. 14A-B and FIG. 15A-E includes a different hot-side regeneration fluid 542 to cold-side regeneration fluid 544 heat exchange architecture, wherein one regeneration fluid flow stream (e.g., 542) spirals in parallel through each layer and the other regeneration fluid flow stream (e.g., 444) flows radially out or in, driving cross-flow heat exchange interaction. In FIG. 15A, upper dual flow layer 532 comprises a hot-side regeneration fluid flow 542 flowing in a spiral or circular flow path. In FIG. 15B, upper dual flow layer 534 comprises cold-side regeneration fluid flow 544 entering from central opening and flowing radially, with hot-side regeneration fluid flow 542 passing through an opening from an immediately adjacent upper to an immediately adjacent lower layer. It should be appreciated that a spiral hot-side regeneration fluid flow/radial cold-side regeneration fluid flow heat exchange flow architecture can be independent of a dual flow-dual flow assembly configuration. FIG. 15C depicts lower dual flow layer 534 comprising hot-side regeneration fluid flow 542, FIG. 15D depicts lower dual flow ambient cooling condenser layer including ambient cooling flow 546 and FIG. 15E illustrates a return condenser layer 538 configured to return regeneration fluid in the regeneration flow path 540 into the cold-side regeneration fluid flow 544.

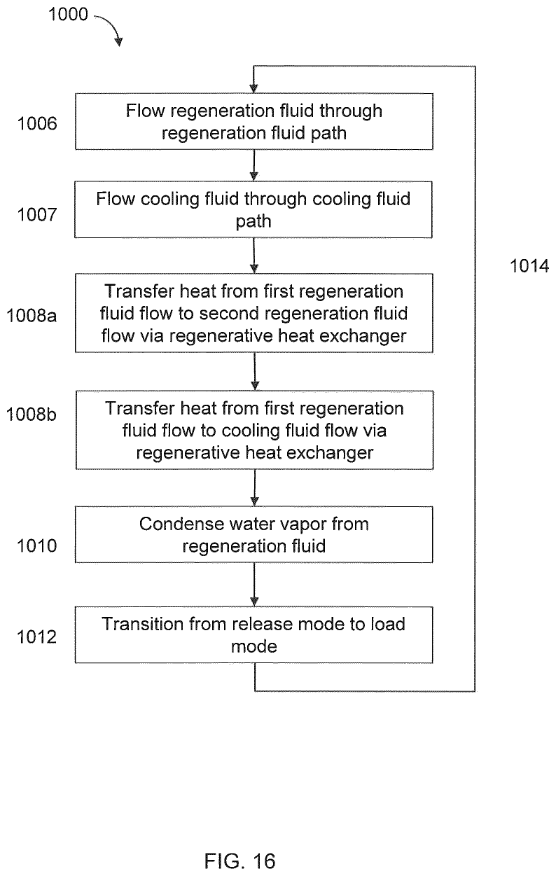

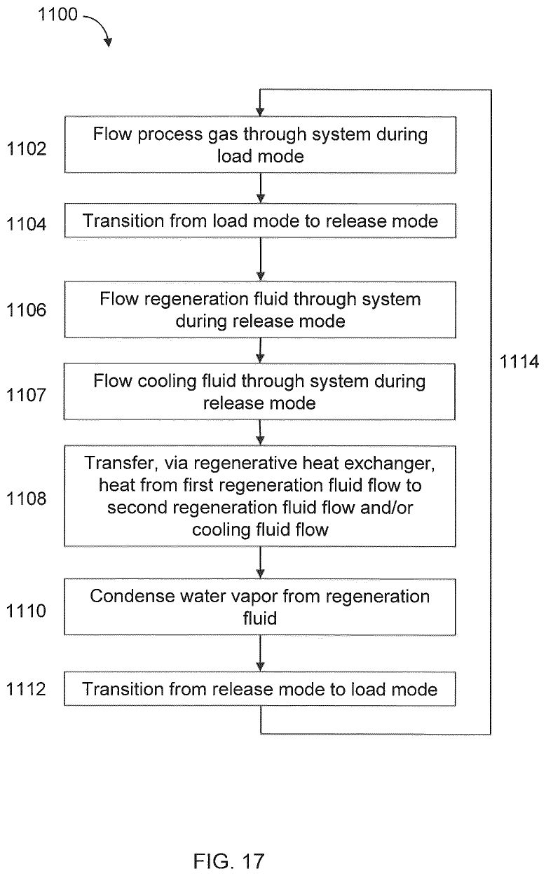

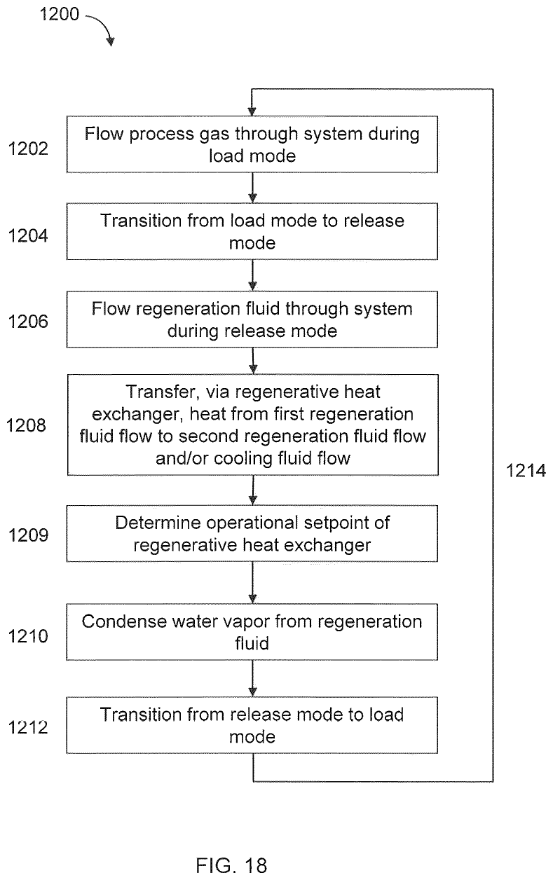

FIG. 16 illustrates method 1000 of operating a recuperative heat exchange system or assembly. Additional illustrative examples of operational methods of operating a water generation system comprising a recuperative heat exchange assembly are depicted in FIG. 17-18. Unless otherwise specified below, the numerical indicators used to refer to operations in FIG. 17-18 are similar to those used to refer operations in FIG. 16, except that the index has been incremented by 100.

At operation 1102, 1202, a process gas (e.g., ambient air) flows through a hygroscopic material or sorption layer during a sorption or loading operational mode or cycle (e.g., nighttime). At operation 1102, 1202, hygroscopic material can capture water vapor from the process gas. In some embodiments, the process gas or ambient air is configured as the cooling fluid and flows through a cooling fluid path of the recuperative heat exchange assembly at operation 1102, 1202.

At operation 1102, 1202, a system controller (e.g., 170) can determine the flow rate of process gas through the water generation system, for example based on or in response to a change or threshold ambient temperature or humidity, time of day, amount of water produced, a solar insolation or irradiance, a power availability and/or the like). In one example, the controller can set or reduce the process gas flow rate or power input level (e.g., to fan assembly 160) to reduce or minimize power consumption such that the length of loading mode or cycle is extended without increasing an onboard battery capacity and/or other power source requirement of the system which can result in a greater amount of water capture and generation for a given loading mode or cycle. In one example, the flow rate of process gas through the water generation system can be between 50-250 cubic feet per minute (CFM), between 100-200 cubic feet per minute (CFM), less than 200 CFM, less than 180 CFM or less than 160 CFM.

At operation 1104, 1204, the method includes transitioning from the sorption or load mode to a desorption, release or regeneration mode (e.g., daytime or morning). In one example, the method comprises monitoring ambient conditions (e.g. solar irradiance, relative humidity, temperature), system power availability, and/or actual or estimated amount of water produced or in a water generation system (e.g. loading equivalent relative humidity of the hygroscopic material) and, based on the monitored or estimated data, transitioning from a loading or sorption mode to a release or desorption mode.

Various methods comprise flowing regeneration fluid or gas along in a regeneration flow path (e.g., via actuating regeneration fan 147) that can include the hygroscopic material at operation 1006. At operation 1006, the regeneration fluid can accumulate both heat and water vapor released from the hygroscopic material.

At operation 1006, 1106, 1206, a system controller (e.g., 170) can determine the flow rate of regeneration fluid through the water generation system, for example based on or in response to a change or threshold temperature or humidity of the regeneration fluid, time of day, amount of water produced, a solar insolation or irradiance, a power availability and/or the like). A system controller (e.g., 170) can determine if a solar insolation, system water content (e.g., absolute humidity of regeneration fluid, equilibrated water of hygroscopic materials or the like) or temperature of the regeneration fluid flowing in the regeneration flow path is above a predetermined threshold (e.g., via a sensor, via calculation or estimation based on amount of captured or produced water and/or the like), a power availability (e.g., battery SOC, PV power). In one example, system controller can reduce the flow rate of the regeneration fluid if a constant solar thermal input is received by the solar thermal unit. Reducing the regeneration fluid flow rate can increase the moisture received from the hygroscopic material resulting in greater water production.

At operation 1007, the method can comprise directing a cooling fluid (e.g., ambient air) through the system during a release or regeneration operational mode. For example, ambient air can be directed (e.g., via fan assembly 160) in a cooling flow path (e.g., 146) of a recuperative heat exchange assembly so as to supplement cooling of a hot-side regeneration fluid by a cold-side regeneration fluid to drive condensation of water from the hot-side regeneration fluid flow. A system controller (e.g., 170) can determine if and/or when a cooling fluid is directed through the system, for example based on or in response to a change or threshold temperature or humidity of the regeneration fluid, time of day, amount of water produced, a solar insolation or irradiance and/or the like). Additionally, the controller can determine a cooling fluid flow rate or power input level (e.g., to fan assembly 160). At operation 1008, the method can comprise transferring, via a recuperative heat exchanger, heat from a hot-side regeneration fluid flow to a cold-side regeneration fluid flow and/or a cooling fluid flow (e.g., ambient air-cooling flow). For example, operation 1008 can comprise transferring heat through a heat exchange surface or plate between a regeneration fluid flow in a hot-side layer or pass of the regeneration flow path to a second regeneration fluid flow in a cold-side layer or pass of the regeneration flow path. Furthermore, operation 1008 can comprise directing a cooling fluid (e.g., ambient air via fan 160) through at least one layer or pass in a cooling flow path located on a side of a heat exchange plate or surface opposite the hot-side regeneration fluid flow. In some embodiments, transfer of heat from a hot-side regeneration fluid flow to a cold-side regeneration fluid flow at operation 1008a can occur sequentially with respect to transferring heat from the hot-side regeneration fluid flow to an ambient cooling fluid flow (i.e., post hot-side/cold-side regeneration fluid heat exchange) at 1008b, for example, via a dual flow-dual-flow flow architecture. However, in other embodiments, heat transfer from hot-side regeneration fluid to both cold-side regeneration fluid and cooling fluid occurs simultaneously, e.g., via a triflow architecture.

At operation 1008, the heat exchange mechanism and/or rate can be varied based on: a user selection, data received from one or more sensors (e.g. data relating to one or more ambient conditions, data relating to water content, etc.), power availability, forecast conditions, programmatic control, an algorithm, combinations thereof, or by any other desirable bases. In on example, the method comprises continuous monitoring of ambient conditions (e.g., solar irradiance, relative humidity, temperature) and/or actual or estimated amount of water in the sorption layer and, based on the monitored or estimated data.

In some implementations, operation 1008 comprises circulating, during the desorption cycle, a refrigerant in a closed loop refrigeration circuit including a refrigerant compressor, a refrigerant condenser, a refrigerant expansion valve, and a refrigerant evaporator. In one example, operation 1008 can include transferring, via the refrigerant condenser, heat from condensation of refrigerant vapor to the sorption layer. In another example, operation 1008 can include transferring, via the refrigerant evaporator, heat from condensation of water vapor in the regeneration gas to the refrigerant.

At operation 1010, the method includes condensing water vapor from the regeneration gas in the regeneration flow path to produce liquid water during the desorption cycle. According to an embodiment, operations 1008 and 1010 can occur simultaneously.

At operation 1012, the method further comprises transitioning from the desorption or regeneration operational mode to the sorption or load mode.

At operation 1014, the process can be repeated or cycled. Transitioning between the desorption mode and sorption mode can be varied based on: a user selection, data received from one or more sensors (e.g. data relating to one or more ambient conditions, data relating to water content, etc.), power availability, forecast conditions, programmatic control, an algorithm, combinations thereof or by any other desirable bases. In one example, the method comprises continuous monitoring of ambient conditions (e.g., solar irradiance, relative humidity, temperature) and/or actual or estimated amount of water in the sorption layer and, based on the monitored or estimated data. In various implementations, the method can include determining if a water mass uptake by the sorption layer is greater than a predetermined mass associated with a nighttime relative humidity (e.g., average relative humidity at the panel) during a during nighttime or sorption time.

At optional step 1209, the controller can adjust or determine one or more system operational ranges and/or setpoints based on an environmental condition (e.g., solar irradiance, ambient temperature) and/or a system state (e.g., amount of onboard power available, a temperature of regeneration fluid flow), so as to efficiently condense water from the regeneration fluid. For example, controller 170 can adjust the flow rate of the regeneration fluid in the regeneration fluid pathway (e.g., via regeneration fan 147), adjust the flow rate of the cooling fluid (e.g., via regeneration fan 147), or a combination thereof. In an embodiment, the controller can operate the system between a plurality of operational modes including: a loading mode wherein the hygroscopic material captures water vapor from a process gas (e.g., ambient air) upon flow in a process flow path; a release mode wherein the regeneration fluid accumulates heat and water vapor upon flow in the regeneration flow path, and, wherein a relative humidity in the regeneration fluid increases upon flow through the recuperative heat exchange assembly; and, a hibernation or power save mode wherein electrical power is not being consumed by the system (e.g., if available power is below a predetermined threshold, if the ambient environment is at a freezing condition).

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

Furthermore, the materials selection and controls approach can be employed for any material systems used in water generators that having a lower and/or upper operational bound or limit relating to a weeping potential, swelling potential, low vapor pressure condition, swelling, a pressure drop on water uptake, mechanical instability, chemical instability, cycling stability, or combinations thereof. Accordingly, the material design and control approaches described herein can be modified such that additional embodiments may be realized with operational, logical, chemical, and/or mechanical changes without departing from the spirit and scope of the disclosure. The claims are not intended to include, and should not be interpreted to include, means-plus- or step-plus-function limitations, unless such a limitation is explicitly recited in a given claim using the phrase(s) “means for” or “step for,” respectively. The term “about” or “substantially,” as used herein, is intended to encompass minor deviations rather define an exact value.

1. A system comprising:
a hygroscopic material configured to capture water vapor from a process gas during a loading operational mode;
a thermal unit configured to heat the hygroscopic material and transfer water vapor released therefrom to a regeneration fluid flowing in a regeneration flow path during a release operational mode;
a recuperative heat exchange assembly comprising:
a recuperator inlet configured to receive a first regeneration fluid flow of the regeneration flow path output from the solar thermal unit;
a recuperator outlet configured to output a second regeneration fluid flow of the regeneration flow path into the solar thermal unit;
a plurality of longitudinally extending heat exchange plates at least partially defining a plurality of first regeneration flow layers alternating between a plurality of cooling flow layers, wherein the first regeneration flow layers direct the first regeneration fluid flow in a direction at least partially counter to the flow direction of the second regeneration fluid flow in an adjacent cooling flow layer; and,
a cooling fluid inlet configured to direct a cooling fluid in a cooling flow path at least partially defined by at least one of the pluralities of longitudinally extending heat exchange plates,
wherein the cooling flow path directs the cooling fluid in a direction at least partially counter to the flow direction of the first regeneration fluid flow in an adjacent first regeneration fluid layer;
wherein the recuperative heat exchange assembly is configured to increase the relative humidity in the first regeneration fluid flow to drive condensation of water vapor therefrom, thereby producing liquid water during a release operational mode.

2. The system of claim 1, further comprising a plurality of spacers located between at least two of the plurality of longitudinally extending heat exchange plates to set a spaced relation therebetween, and to define intervening passages between alternate flow layers.

3. The system of claim 1, further comprising a plenum comprising the recuperator inlet configured to input the first regeneration fluid flow and the recuperator outlet configured to output the second regeneration fluid flow;
wherein the plenum comprises a flow divider separating the first regeneration fluid flow and the second regeneration fluid flow.

4. The system of claim 1, further comprising at least one of:
a fan assembly configured to adjust a flow rate of the regeneration fluid in the regeneration flow path during the release mode;
a fan assembly configured to adjust a flow rate of the cooling fluid in the cooling fluid path during the release mode; or a combination thereof.

5. The system of claim 1, comprising a return plenum for collecting liquid water condensed from the regeneration fluid, and to direct the regeneration fluid into the second regeneration fluid flow.

6. The system of claim 1, wherein each heat exchange plate comprises one or more spacers supported on a surface of the heat exchange plate defining a portion of the regeneration flow path, the cooling flow path, or a combination thereof.

7. The system of claim 1, wherein one or more of the heat exchange plates comprises an opening proximate a first edge of the plate and an opening proximate a second edge of the plate opposite from the first edge of the plate.

8. The system of claim 1, wherein one or more of the heat exchange plates comprises a single opening proximate one edge of the plate and at least two openings at an opposing edge of the plate.

9. The system of claim 1, further comprising a triflow architecture including alternating layers of the first regeneration fluid flow and dual cooling flow layers, each dual cooling flow layer including the second regeneration fluid flow and the cooling fluid flow.

10. The system of claim 1, further comprising a sectional flow architecture including:
a first dual flow section comprising alternating layers of the first regeneration fluid flow 142 and the second regeneration fluid flow; and,
a second triflow section comprising alternating layers of the first regeneration fluid flow 142 and dual cooling flow layers, each dual cooling flow layer including the second regeneration fluid flow and the cooling fluid flow.

11. The system of claim 1, wherein at least one of the cooling layers is a dual flow cooling layer comprising a flow divider defining a regeneration fluid section to direct the second regeneration fluid flow therethrough, and a cooling fluid section to direct the cooling fluid flow therethrough.

12. The system of claim 1, wherein the recuperative heat exchange assembly comprises a sectional flow architecture including:
a first dual flow section comprising alternating layers of the first regeneration fluid flow 142 and a cooling flow layer including the second regeneration fluid flow; and,
a second dual flow section comprising alternating layers of the first regeneration fluid flow and a cooling flow layer including the cooling fluid flow.

13. The system of claim 1, wherein the recuperative heat exchange assembly is configured as a monolithic structure.

14. The system of claim 1, wherein the recuperative heat exchange assembly is configured to maintain a regeneration gas flux in the regeneration flow path greater than 30 CFM and a pressure drop less than 0.5 inches water.

15. The system of claim 1, wherein a temperature difference between the regeneration fluid input to the recuperative heat exchanger and the regeneration fluid output from the recuperative heat exchanger is less than 40 degrees Celsius.

16. The system of claim 1, further comprising a controller configured to adjust the amount of electrical energy directed to the cooling fan assembly or the regeneration fluid fan based on: an environmental condition, a system power state, a system water content, a system temperature, or combinations thereof.

17. The system of claim 1, wherein the controller operates the system between a plurality of operational modes including:
a loading mode wherein the hygroscopic material captures water vapor from the process gas upon flow in a process flow path;
a release mode wherein the regeneration fluid accumulates heat and water vapor upon flow in the regeneration flow path, and, wherein a relative humidity in the regeneration fluid increases upon flow through the recuperative heat exchange assembly; and,
a hibernation or power saving mode wherein electrical power is not being consumed by the system.

18. The system of claim 1, wherein the thermal unit is a solar thermal comprising the hygroscopic material arranged in one or more porous hygroscopic layers,
wherein the one or more porous hygroscopic layers are configured to capture water vapor from the process gas flowing therethrough during a loading operational mode; and
wherein the regeneration fluid accumulates heat and water vapor upon flowing through the one or more porous hygroscopic layers during the release operational mode.

19. The system of claim 1, wherein the system further comprises a solar unit configured to convert solar radiation impinging thereon into heat and electrical energy; and wherein the electrical energy produced by the solar unit is used to power at least one fan to flow the regeneration fluid in the regeneration fluid path, the cooling fluid in the cooling flow path, or a combination thereof.

20. A method for generating water comprising:
directing a regeneration fluid in a closed-loop regeneration flow path 140 through a recuperative heat exchanger including:
directing a first regeneration fluid flow through a hot-side layer located on a first side of a heat exchange plate; and,
directing a second regeneration fluid flow through a cooling layer located on an opposing side of the heat exchange plate, the second regeneration fluid flow direction being generally counter to the first regeneration fluid flow direction;
directing a cooling fluid through at least one pass in a cooling flow path located on the opposing side of the heat exchange plate;
transferring heat through the heat exchange plate between the first regeneration fluid flow in the hot-side layer of the regeneration flow path and the second regeneration fluid flow in the cooling layer of the regeneration flow path;
transferring heat through the heat exchange plate between the first regeneration fluid flow in the hot-side layer of the regeneration flow path and the cooling fluid in the at least one cooling layer; and,
condensing water vapor from the first regeneration fluid flow.

21. The method of claim 20, further comprising:
flowing a process gas through a hygroscopic material to capture water vapor from the process gas during a loading operational mode;
transitioning from the loading operational mode to a release operational mode;
flowing the regeneration fluid, during the release operational mode, through the hygroscopic material to accumulate heat and water vapor therefrom.

22. A system for generating water from air comprising:
a hygroscopic material configured to capture water vapor from air flowing in a process flow path during a loading operational mode;
a thermal unit configured to heat the hygroscopic material and transfer water vapor released therefrom to a regeneration fluid flowing in a regeneration flow path during a release operational mode;
a heat exchange assembly;
a valve assembly comprising:
a housing defining one or more flow channels having a flow channel axis;
a slide plate movable transversely to the flow channel axis between a first position and a second position;
an actuator configured to reciprocate the slide plate between the first position and the second position;
wherein ambient air flowing in the process flow path is allowed to pass through the one or more flow channels in the first position, and the slide plate seals the flow channel in the second position.

23. The system of claim 22, wherein the housing comprises an annular surface defining the flow channel.

24. The system of claim 22, further comprising one or more gaskets positioned between the annular surface of the housing and the slide plate.

25. The system of claim 22, wherein the heat exchange assembly comprises:
a plurality of longitudinally extending heat exchange plates at least partially defining a plurality of first regeneration flow layers alternating between a plurality of cooling flow layers;
wherein the first regeneration flow layers direct the regeneration fluid flow in a direction at least partially counter to the flow direction of the plurality of cooling flow layers;
wherein the heat exchange assembly is configured to increase the relative humidity in the regeneration fluid to drive condensation of water vapor therefrom, thereby producing liquid water during a release operational mode.
